(19) United States
(12) Patent Application Publication
(10) Pub. No.: US 2008/0039556 A1
(43) Pub. Date: Feb. 14, 2008

(54) Encapsulated Epoxy-Resin Molding Compound, And Electronic Component Device

(75) Inventors: Ryoichi Ikezawa, Ibaraki (JP); Hidetaka Yoshizawa, Ibaraki (JP); Seiichi Akagi, Ibaraki (JP)

Correspondence Address: GRIFFIN & SZIPL, PC, SUITE PH-1, 2300 NINTH STREET, SOUTH, ARLINGTON, VA, 22204, US

(73) Assignee: HITACHI CHEMICAL CO., LTD., Tokyo (JP)

(21) Appl. No.: 11/572,155

(22) PCT Filed: Jul. 12, 2005
(86) PCT No.: PCT/JP05/12830

§ 371 Date: Jan. 16, 2007

(30) Foreign Application Priority Data
Jul. 13, 2004 (JP) 2004-206388

(51) Int. Cl. C08L 63/00; C08K 9/02

(52) U.S. Cl. 523/451; 523/457; 523/458; 523/466

(57) ABSTRACT

The present invention relates to an encapsulated epoxy-resin molding compound, comprising an epoxy resin (A), a hardening agent (B), and magnesium hydroxide (C), wherein the magnesium hydroxide (C) contains magnesium hydroxide coated with silica, and provides a non-halogenated and non-antimony encapsulated epoxy-resin molding compound superior in flame resistance moldability and also in reliability such as reflow resistance, moisture resistance, high-temperature storage stability, and thus, favorable for sealing VLSI, and an electronic component device carrying an element sealed with the molding compound.

This is a National Phase Application in the United States of International Patent Application No. PCT/JP2005/012830 filed Jul. 12, 2005, which claims priority on Japanese Patent Application No. 2004-206388, filed Jul. 13, 2004. The entire disclosures of the above patent applications are hereby incorporated by reference.

### TECHNICAL FIELD

The present invention relates to an encapsulated epoxy-resin molding compound and an electronic component device sealed with the molding compound.

### BACKGROUND ART

Resin sealing has been mainly used in the field of sealing element for electronic component devices such as transistor and IC from the points of productivity, cost, and other, and epoxy resin molding compounds have been used widely. It is because epoxy resins are well balanced in electrical properties, moisture resistance, heat resistance, mechanical properties, adhesiveness to inert materials, and others. These encapsulated epoxy-resin molding compounds are flame proofed mainly with a combination of antimony oxide and a brominated resin such as tetrabromobisphenol A diglycidyl ether.

In the recent move for regulation of halogenated resins and antimony compounds for environmental protection, there exist an increasing needed for non-halogenated (non-brominated) and non-antimony encapsulated epoxy-resin molding compounds. In addition, bromine compounds are known to show an adverse effect on the high-temperature storage stability of plastic-sealed IC's. It is desirable to reduce the amount of brominated resin also from the viewpoint.

There are many proposed flame-proofing methods without use of a brominated resin and antimony oxide, an examples thereof include methods of using flame retardants without a halogen and antimony such as methods of using red phosphorus (see, for example, JP-A No. 9-227765), a phosphoric ester compound (see, for example, JP-A No. 9-235449), a phosphazene compound (see, for example, JP-A No. 8-225714), a metal hydroxide (see, for example, JP-A No. 9-241483), a metal hydroxide and a metal oxide in combination (see, for example, JP-A No. 9-100337), a cyclopentadienyl compound such as ferrocene (see, for example, JP-A No. 11-269349), or an organic metal compound such as copper acetylacetonate (see, for example, Hiroshi Kato, Functional Material (CMC Publishing), 11 (6), 34 (1991)); methods of increasing the content of filler (see, for example, JP-A No. 7-82343); and methods of using a high-flame-retardancy resin (see, for example, JP-A No. 11-140277); methods of using a surface-treated metal hydroxide (see, for example, JP-A Nos. 1-245039 and 10-338818); and the like.

### SUMMARY OF THE INVENTION

However, there is a problem of deterioration in moisture resistance when red phosphorus is used in the encapsulated epoxy-resin molding compound, problems of deterioration in moldability by plasticization and in moisture resistance when a phosphoric ester or phosphazene compound is used, problems of deterioration in flowability and mold release efficiency when a metal hydroxide is used, or a problem of deterioration in flowability when a metal oxide is used or when the filler content is raised. In addition, there is a problem of inhibition of hardening reaction and thus, deterioration in moldability when an organic metal compound such as copper acetylacetonate is used. Further, in the method of using a high flame-retardancy resin, flame resistance of the material obtained could not satisfy the requirements for the material of the electronic component devices specified by UL-94 V-0 sufficiently.

Among metal hydroxides, magnesium hydroxide is higher in heat resistance, and thus, a possibility of using it favorably in encapsulated epoxy-resin molding compounds was suggested. However, magnesium hydroxide demand addition of a great amount of it for sufficient flame resistance and thus, caused a problem of deterioration in moldability such as flowability. It is also poor in acid resistance and caused a problem of corrosion and whitening of the surface in the solder-plating step during production of semiconductor devices. These problems could not be overcome even by the surface treatment described above.

As described above, it was not possible to obtain moldability, reliability and flame resistance same as those of the encapsulated epoxy-resin molding compounds using a brominated resin and antimony oxide in combination, by any of the use of non-halogen, non-antimony flame retardant, and the methods of raising the content of filler and of using a high flame-resistant resin.

An object of the present invention, which was made under the circumstances above, is to provide a non-halogenated and non-antimony encapsulated epoxy-resin compound superior in flame resistance and still retaining moldability, reliability such as reflow resistance, moisture resistance and high-temperature storage, and an electronic component device containing elements sealed with the same.

After intensive studies to solve the problems above, the present inventors have found that it was possible to achieve the object by using an encapsulated epoxy-resin molding compound containing a particular magnesium hydroxide, and completed the present invention.

The present invention has the following aspects (1) to (29).

(1) An encapsulated epoxy-resin molding compound comprising an epoxy resin (A), a hardening agent (B), and magnesium hydroxide (C), wherein the magnesium hydroxide (C) contains magnesium hydroxide coated with silica.

(2) The encapsulated epoxy-resin molding compound described in (1), wherein the magnesium hydroxide coated with silica has a coating layer consisting of silica in an amount of 0.1 to 20% by mass relative to magnesium hydroxide in terms of SiO₂ conversion.

(3) The encapsulated epoxy-resin molding compound described in (1) or (2), wherein the magnesium hydroxide coated with silica contains magnesium hydroxide whose silica coating layer is overcoated with at least one selected from alumina, titania, and zirconia.

(4) The encapsulated epoxy-resin molding compound described in (1) or (2), wherein the magnesium hydroxide coated with silica contains magnesium hydroxide whose silica coating layer contains at least one selected from alumina, titania, and zirconia.

(5) The encapsulated epoxy-resin molding compound described in (3) or (4), wherein at least one selected from alumina, titania and zirconia overcoats the silica coating layer or is contained in the silica coating layer in an amount of 0.03 to 10% by mass relative to magnesium hydroxide in terms of Al₂O₃, TiO₂, and ZrO₂ conversion.

(6) The encapsulated epoxy-resin molding compound described in (1) or (2), wherein the magnesium hydroxide coated with silica is surface-treated the silica coating layer with at least one surface treating agent selected from higher fatty acids, alkali metal salts of higher fatty acids, polyhydric alcohol higher fatty acid esters, anionic surfactants, phosphoric acid esters, silane coupling agents, aluminum coupling agents, titanate coupling agents, organosilanes, organosiloxanes, and organosilazanes.

(7) The encapsulated epoxy-resin molding compound described in anyone of (3) to (5), wherein the magnesium hydroxide having the silica coating layer which is overcoated with or contains at least one selected from alumina, titania, and zirconia is further surface-treated with at least one surface treating agent selected from higher fatty acids, alkali metal salts of higher fatty acids, polyhydric alcohol higher fatty acid esters, anionic surfactants, phosphoric acid esters, silane coupling agents, aluminum coupling agents, titanate coupling agents, organosilanes, organosiloxanes, and organosilazanes.

(8) The encapsulated epoxy-resin molding compound described in anyone of (1) to (7), wherein the magnesium hydroxide (C) is contained in an amount of 5 to 300 mass parts with respect to 100 mass parts of the epoxy resin (A).

(9) The encapsulated epoxy-resin molding compound described in to any one of (1) to (8), further comprising a metal oxide (D).

(10) The encapsulated epoxy-resin molding compound described in (9), wherein the metal oxide (D) is selected from oxides of typical metal elements and transition metal elements.

(11) The encapsulated epoxy-resin molding compound described in (10), wherein the metal oxide (D) is at least one of the oxides of zinc, magnesium, copper, iron, molybdenum, tungsten, zirconium, manganese and calcium.

(12) The encapsulated epoxy-resin molding compound described in any one of (1) to (11), wherein the epoxy resin (A) contains at least one of a biphenyl-based epoxy resin, a bisphenol F-based epoxy resin, a stilbene-based epoxy resin, a sulfur atom-containing epoxy resin, a novolak-based epoxy resin, a dicyclopentadiene-based epoxy resin, a naphthalene-based epoxy resin, a triphenylmethane-based epoxy resin, a biphenylene-based epoxy resin and a naphthol-aralkyl-based phenol resin.

(13) The encapsulated epoxy-resin molding compound described in (12), wherein the sulfur atom-containing epoxy resin is a compound represented by the following General Formula (I):

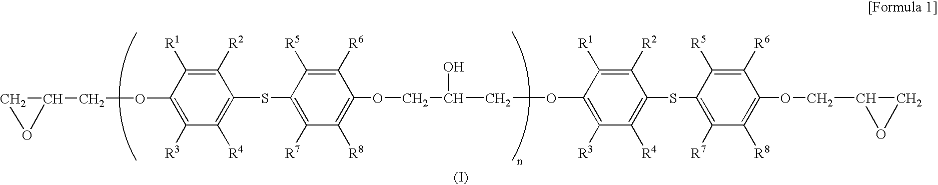

(in General Formula (I), R¹ to R⁸ are selected from a hydrogen atom and substituted or unsubstituted monovalent hydrocarbon groups having 1 to 10 carbon atoms and may be the same as or different from each other; and n is an integer of 0 to 3).

(14) The encapsulated epoxy-resin molding compound described in any one of (1) to (13), wherein the hardening agent (B) contains at least one of a biphenyl-based phenol resin, an aralkyl-based phenol resin, a dicyclopentadiene-based phenol resin, a triphenylmethane-based phenol resin and a novolak-based phenol resin.

(15) The encapsulated epoxy-resin molding compound described in any one of (1) to (14), further comprising a hardening accelerator (E).

(16) The encapsulated epoxy-resin molding compound described in (15), wherein the hardening accelerator (E) contains an adduct of a phosphine compound with a quinone compound.

(17) The encapsulated epoxy-resin molding compound described in (16), wherein the hardening accelerator (E) contains an adduct of a phosphine compound having at least one alkyl group bound to the phosphorus atom and a quinone compound.

(18) The encapsulated epoxy-resin molding compound described in any one of (1) to (17), further comprising a coupling agent (F).

(19) The encapsulated epoxy-resin molding compound described in (18), wherein the coupling agent (F) contains a secondary amino group-containing silane-coupling agent.

(20) The encapsulated epoxy-resin molding compound described in (19), wherein the secondary amino group-containing silane-coupling agent contains a compound represented by the following General Formula (II):

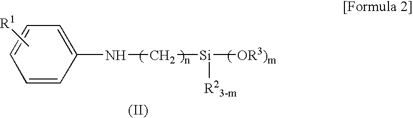

(in General Formula (II), R¹ is selected from a hydrogen atom, alkyl groups having 1 to 6 carbon atoms and alkoxyl groups having 1 to 2 carbon atoms; R² is selected from alkyl groups having 1 to 6 carbon atoms and a phenyl group; R³ represents a methyl or ethyl group; n is an integer of 1 to 6; and m is an integer of 1 to 3).

(21) The encapsulated epoxy-resin molding compound described in any one of (1) to (20), further comprising a phosphorus atom-containing compound (G).

(22) The encapsulated epoxy-resin molding compound described in (21), wherein the phosphorus atom-containing compound (G) contains a phosphoric ester compound.

(23) The encapsulated epoxy-resin molding compound described in (22), wherein the phosphoric ester compound contains a compound represented by the following General Formula (III):

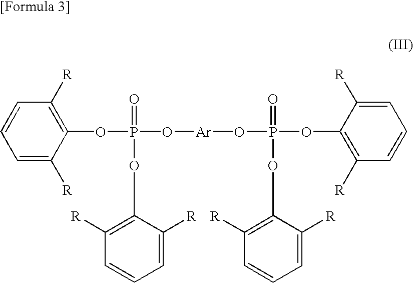

(in General Formula (III), eight groups Reach represent an alkyl group having 1 to 4 carbon atoms and may be all the same or different from each other; and Ar represents an aromatic ring).

(24) The encapsulated epoxy-resin molding compound described in (21), wherein the phosphorus atom-containing compound (G) contains a phosphine oxide, which in turn contains a phosphine compound represented by the following General Formula (IV):

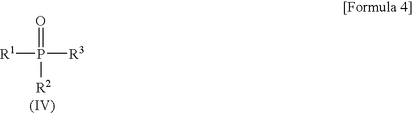

(in General Formula (IV), R¹, R² and R³ each represent a substituted or unsubstituted alkyl, aryl, or aralkyl group having 1 to 10 carbon atoms or a hydrogen atom and may be the same as or different from each other; however, all of the groups are not hydrogen atoms at the same time).

(25) The encapsulated epoxy-resin molding compound described in any one of (1) to (24), further comprising a straight-chain oxidized polyethylene having a weight-average molecular weight of 4,000 or more (H) and a compound (I) obtained by esterifying a copolymer of an α-olefin having 5 to 30 carbon atoms and maleic anhydride with a monovalent alcohol having 5 to 25 carbon atoms.

(26) The encapsulated epoxy-resin molding compound described in (25), wherein at least one of the components (H) and (I) is mixed with part or all of the component (A) previously.

(27) The encapsulated epoxy-resin molding compound described in any one of (1) to (26), further comprising an inorganic filler (J).

(28) The encapsulated epoxy-resin molding compound described in (27), wherein the total content of the magnesium hydroxide (C) and the inorganic filler (J) is 60 to 95 mass % with respect to the encapsulated epoxy-resin molding compound.

(29) An electronic component device, comprising an element sealed with the encapsulated epoxy-resin molding compound described in to any one of (1) to (28).

The encapsulated epoxy-resin molding compound according to the present invention provides products such as electronic component devices superior in flame resistance and also, in reliability such as moldability, reflow resistance, moisture resistance, and high-temperature storage stability, and thus, is significantly valuable industrially.

The present disclosure relates to the Claims in Japanese Patent Application No. 2004-206388 filed on Jul. 13, 2004, the disclosure of which is incorporated by reference herein.

### BEST MODE OF CARRYING OUT THE INVENTION

The epoxy resin (A) used in the present invention is not particularly limited, if it is a material commonly used as an encapsulated epoxy-resin molding compound, and example thereof include epoxides of novolac resins (novolak-based epoxy resins) prepared by condensation or cocondensation of a phenol such as phenol, cresol, xylenol, resorcin, catechol, bisphenol A, or bisphenol F and/or a naphthol such as α-naphthol, β-naphthol, or dihydroxynaphthalene with an aldehyde group-containing compound such as formaldehyde, acetaldehyde, propionaldehyde, benzaldehyde, or salicylaldehyde under acidic catalyst, including phenolic novolak-based epoxy resins, ortho-cresol novolak-based epoxy resins, and triphenylmethane skeleton-containing epoxy resins (triphenylmethane-based epoxy resins); diglycidyl ethers such as bisphenol A, bisphenol F, bisphenol S, and alkyl-substituted or unsubstituted biphenols; stilbene-based epoxy resins; hydroquinone-based epoxy resins; glycidyl ester form epoxy resins prepared in reaction of a polybasic acid such as phthalic acid or dimer acid with epichlorohydrin; glycidylamine-based epoxy resins prepared in reaction of a polyamine such as diaminodiphenylmethane or isocyanuric acid with epichlorohydrin; epoxides of a cocondensation resin from dicyclopentadiene and phenols (dicyclopentadiene-based epoxy resins); epoxy resin containing a naphthalene ring (naphthalene-based epoxy resin); epoxides of an aralkyl-based phenol resin such as phenol-aralkyl resins and naphthol-aralkyl resins; biphenylene-based epoxy resins; trimethylolpropane-based epoxy resins; terpene modification epoxy resins; linear aliphatic epoxy resins prepared by oxidation of an olefin bond with a peracid such as peracetic acid; alicyclic epoxy resins; sulfur atom-containing epoxy resins; and the like, and these resins may be used alone or in combination of two or more.

Among them, biphenyl-based epoxy resins, bisphenol F-based epoxy resins, stilbene-based epoxy resins and sulfur atom-containing epoxy resins are preferable from the viewpoint of reflow resistance; novolak-based epoxy resins are preferable from the viewpoint of hardening efficiency; dicyclopentadiene-based epoxy resins are preferable from the viewpoint of low hygroscopicity; naphthalene-based epoxy resins and triphenylmethane-based epoxy resins are preferable from the viewpoints of heat resistance and warpage resistance; and biphenylene-based epoxy resins and naphthol-aralkyl-based epoxy resins are preferable from the viewpoints of flame resistance. The encapsulated epoxy-resin molding compound according to the present invention preferably contains at least one of these epoxy resins.

Examples of the biphenyl-based epoxy resins include the epoxy resins represented by the following General Formula (V) and the like; examples of the bisphenol F-based epoxy resins include the epoxy resins represented by the following General Formula (VI) and the like; examples of the stilbene-based epoxy resins include the epoxy resins represented by the following General Formula (VII) and the like; and examples of the sulfur atom-containing epoxy resins include the epoxy resins represented by the following General Formula (I) and the like.

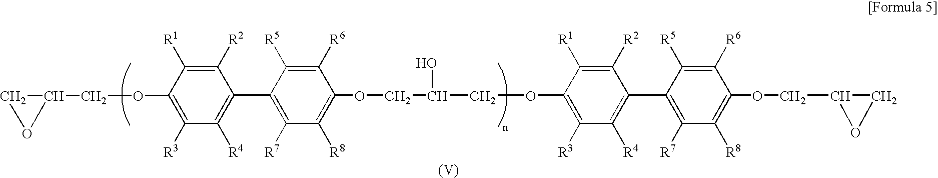

(wherein, R¹ to R⁸ each represent a group selected from a hydrogen atom and substituted or unsubstituted monovalent hydrocarbon groups having 1 to 10 carbon atoms and may be the same as or different from each other; and n is an integer of 0 to 3).

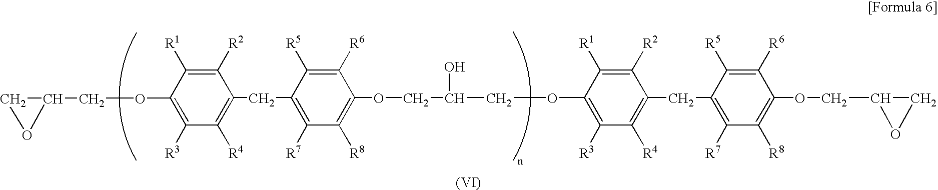

(in General Formula (VI), R¹ to R⁸ each represent a group selected from a hydrogen atom, alkyl group having 1 to 10 carbon atoms, alkoxyl groups having 1 to 10 carbon atoms, aryl groups having 6 to 10 carbon atoms, and aralkyl groups having 6 to 10 carbon atoms and may be the same as or different from each other; and n is an integer of 0 to 3).

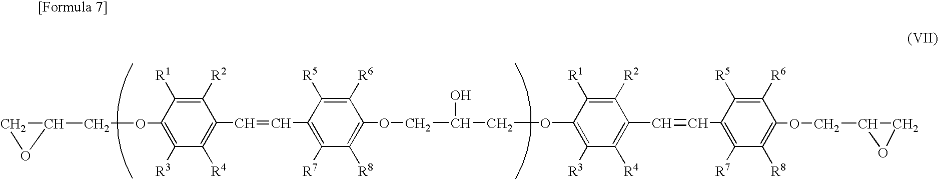

(in General Formula (VII), R¹ to R⁸ each represent a group selected from a hydrogen atom and substituted or unsubstituted monovalent hydrocarbon groups having 1 to 5 carbon atoms and may be the same or different from each other; and n is an integer of 0 to 10).

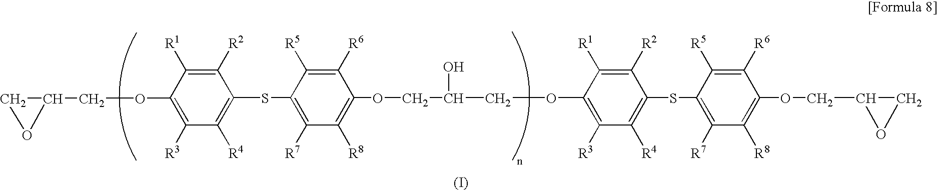

(in General Formula (I), R¹ to R⁸ each represent a group selected from a hydrogen atom, substituted or unsubstituted alkyl groups having 1 to 10 carbon atoms, and substituted or unsubstituted alkoxyl groups having 1 to 10 carbon atoms and may be the same or different from each other; and n is an integer of 0 to 3).

Examples of the biphenyl-based epoxy resins represented by General Formula (V) include epoxy resins containing 4,4′-bis(2,3-epoxypropoxy)biphenyl or 4,4′-bis(2,3-epoxypropoxy)-3,3′,5,5′-tetramethylbiphenyl as the principal component; epoxy resins prepared in reaction of epichlorohydrin and 4,4′-biphenol or 4,4′-(3,3′,5,5′-tetramethyl)biphenol; and the like. Among them, epoxy resins containing 4,4′-bis(2,3-epoxypropoxy)-3,3′,5,5′-tetramethylbiphenyl as the principal component are preferable. Commercially available products thereof include YX-4000 (trade name, manufactured by Japan Epoxy Resin Co., Ltd.) containing the compound wherein n is 0 as the main component, and the like.

For example, the bisphenol F-based epoxy resin represented by General Formula (VI), wherein R¹, R³, R⁶ and R⁸ are methyl groups, R²R⁴, R⁵ and R⁷ are hydrogen atoms, and n is 0, as the principal component, such as YSLV-80XY (trade name, manufactured by Nippon Steel Chemical Co., Ltd.), are available on the market.

The stilbene-based epoxy resin represented by General Formula (VII) can be prepared in reaction of a raw stilbene-based phenol and epichlorohydrin in the presence of a basic substance. Examples of the raw stilbene-based phenols include 3-t-butyl-4,4′-dihydroxy-3′,5,5′-trimethylstilbene, 3-t-butyl-4,4′-dihydroxy-3′,5′,6-trimethylstilbene, 4,4′-dihydroxy-3,3′,5,5′-tetramethylstilbene, 4,4′-dihydroxy-3,3′-di-t-butyl-5,5′-dimethylstilbene, 4,4′-dihydroxy-3,3′-di-t-butyl-6,6′-dimethylstilbene, and the like; and, among them, 3-t-butyl-4,4′-dihydroxy-3′,5,5′-trimethylstilbene and 4,4′-dihydroxy-3,3′,5,5′-tetramethylstilbene are preferable. These stilbene-based phenols may be used alone or in combination of two or more.

Among the sulfur atom-containing epoxy resins represented by General Formula (I), epoxy resins in which R², R³, R⁶ and R⁷ are hydrogen atoms and R¹, R⁴, R⁵ and R⁸ are alkyl groups are preferable; and epoxy resins in which R², R³, R⁶ and R⁷ are hydrogen atoms, R¹ and R⁸ are tert-butyl groups, and R⁴ and R⁵ are methyl groups are more preferable. Commercially available products of such compounds include YSLV-120TE (trade name, manufactured by Tohto Kasei Co., Ltd.) and the like.

These epoxy resins may be used alone or in combination of two or more, but the total blending rate is preferably 20 mass % or more, more preferably 30 mass % or more, and still more preferably 50 mass % or more, with respect to the total amount of the epoxy resin, for making the resin show its favorable properties.

Examples of the novolak-based epoxy resins include the epoxy resins represented by the following General Formula (VIII) and the like.

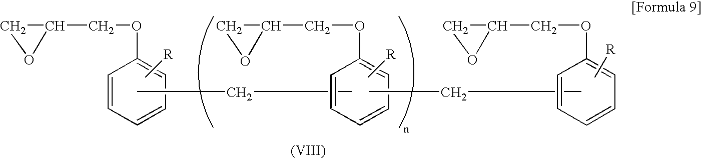

(in General Formula (VIII), R is a group selected from a hydrogen atom and substituted or unsubstituted monovalent hydrocarbon groups having 1 to 10 carbon atoms; and n is an integer of 0 to 10).

The novolak-based epoxy resin represented by General Formula (VIII) can be prepared easily in reaction of a novolak phenol resin with epichlorohydrin. R in General Formula (VIII) is preferably an alkyl group having 1 to 10 carbon atoms such as methyl, ethyl, propyl, butyl, isopropyl, or isobutyl, or an alkoxyl group having 1 to 10 carbon atoms such as methoxy, ethoxy, propoxy, or butoxy, and more preferably a hydrogen atom or a methyl group. n is preferably an integer of 0 to 3. o-Cresol novolak epoxy resins are preferable among the novolak-based epoxy resins represented by General Formula (VIII). Commercially available products of such compounds include N-600 series products (trade name, manufactured by Dainippon Ink and Chemicals, Inc.) and others.

When a novolak-based epoxy resin is used, the blending rate is preferably 20 mass % or more, more preferably 30 mass % or more with respect to the total amount of the epoxy resin, for making the resin show its favorable properties.

Examples of the dicyclopentadiene-based epoxy resins include the epoxy resins represented by the following General Formula (IX) and the like.

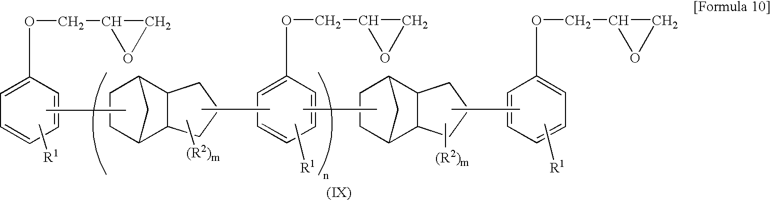

(in General Formula (IX), R¹ and R² each independently represent a group selected from a hydrogen atom and substituted or unsubstituted monovalent hydrocarbons group having 1 to 10 carbon atoms; n is an integer of 0 to 10; and m is an integer of 0 to 6).

Examples of the group R¹ in Formula (IX) include a hydrogen atom; alkyl groups such as methyl, ethyl, propyl, butyl, isopropyl, and tert-butyl; alkenyl groups such as vinyl, allyl, and butenyl; and substituted or unsubstituted monovalent hydrocarbon group having 1 to 5 carbon atoms such as alkyl halide groups, amino group-substituted alkyl groups, and mercapto group-substituted alkyl groups; among them, alkyl groups such as methyl and ethyl and a hydrogen atom are preferably; and a methyl group and a hydrogen atom are more preferable. Examples of the group R² include a hydrogen atom; alkyl groups such as methyl, ethyl, propyl, butyl, isopropyl, and t-butyl; alkenyl groups such as vinyl, allyl, and butenyl; and substituted or unsubstituted monovalent hydrocarbon group having 1 to 5 carbon atoms such as alkyl halide groups, amino group-substituted alkyl groups, and mercapto group-substituted alkyl groups; and among them, a hydrogen atom is preferable. Commercially available products of such compounds include HP-7200 (trade name, manufactured by Dainippon Ink and Chemicals, Inc.) and the like.

When a dicyclopentadiene-based epoxy resin is used, the blending rate is preferably 20 mass % or more, more preferably 30 mass % or more, with respect to the total amount of the epoxy resin, for making the resin show its favorable properties.

Examples of the naphthalene-based epoxy resins include the epoxy resins represented by the following General Formula (X) and the like; and examples of the triphenylmethane-based epoxy resins include those represented by the following General Formula (XI) and the like.

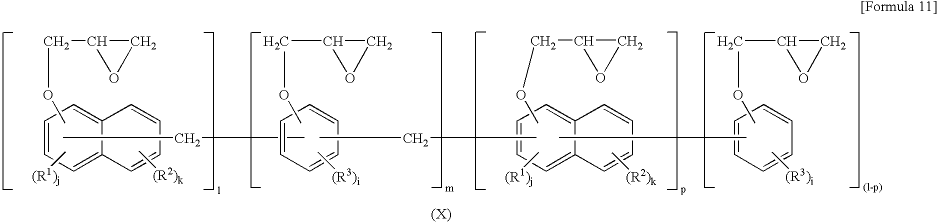

(in General Formula (X), R¹ to R³ each represent a group selected from a hydrogen atom and substituted or unsubstituted monovalent hydrocarbons group having 1 to 12 carbon atoms and may be the same or different from each other; p is 1 or 0; and each of 1 and m is an integer of 0 to 11 satisfying the conditions that (1+m) is an integer of 1 to 11 and (1+p) is an integer of 1 to 12; i is an integer of 0 to 3; j is an integer of 0 to 2; and k is an integer of 0 to 4).

Examples of the naphthalene-based epoxy resins represented by General Formula (X) include random copolymers containing 1 constituent units and m other constituent units randomly, alternating copolymers containing them alternately, ordered copolymers containing them orderly, and block copolymers containing them blockwise; and these may be use alone or in combination of two or more.

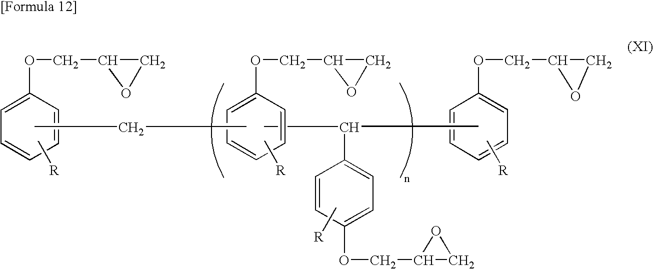

(in General Formula (XI), R is a group selected from a hydrogen atom and substituted or unsubstituted monovalent hydrocarbon groups having 1 to 10 carbon atoms; and n is an integer of 1 to 10). Commercially available products of the triphenylmethane-based epoxy resins represented by General Formula (XI) include, for example, EPPN-500 series products (trade name, manufactured by Nippon Kayaku Co., Ltd.).

These epoxy resins may be used alone or in combination of two or more, but the total blending rate is preferably 20 mass % or more, more preferably 30 mass % or more, and still more preferably 50 mass % or more, with respect to the total amount of the epoxy resin, for making the resin show its favorable properties.

The biphenyl-based epoxy resins, bisphenol F-based epoxy resins, stilbene-based epoxy resins, sulfur atom-containing epoxy resins, novolak-based epoxy resins, dicyclopentadiene-based epoxy resins, naphthalene-based epoxy resins and triphenylmethane-based epoxy resins may be used alone or in combination of two or more, but the total blending rate is preferably 50 mass % or more, more preferably 60 mass % or more, and still more preferably 80 mass % or more, with respect to the total amount of the epoxy resin.

Examples of the biphenylene-based epoxy resins include the epoxy resins represented by the following General Formula (XII) and the like; and examples of the naphthol-aralkyl-based epoxy resins include the epoxy resins represented by the following General Formula (XIII) and the like.

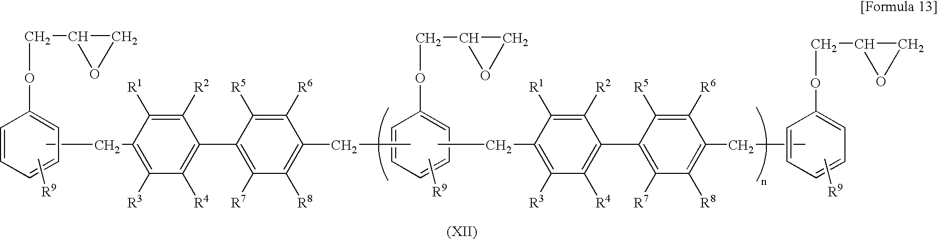

(in General Formula (XII), R¹ to R⁹ may be the same or different from each other, and each represent a group selected from a hydrogen atom; alkyl groups having 1 to 10 carbon atoms such as methyl, ethyl, propyl, butyl, isopropyl, and isobutyl; alkoxyl groups having 1 to 10 carbon atoms such as methoxy, ethoxy, propoxy, and butoxy; aryl group having 6 to 10 carbon atoms such as phenyl, tolyl, and xylyl; and, aralkyl group having 6 to 10 carbon atoms such as benzyl and phenethyl; among them, a hydrogen atom and a methyl group are preferable; and n is an integer of 0 to 10).

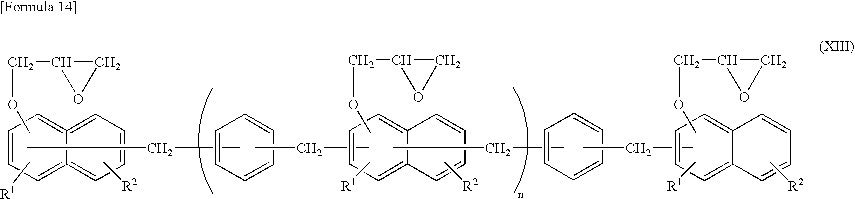

(in General Formula (XIII), R¹ to R² each represent a group selected from a hydrogen atom and substituted or unsubstituted monovalent hydrocarbons group having 1 to 12 carbon atoms and may be the same or different from each other; and n is an integer of 1 to 10). Commercially available products of the biphenylene-based epoxy resins include NC-3000 (trade name, manufactured by Nippon Kayaku Co., Ltd.). Commercially available products of the naphthol-aralkyl-based epoxy resins include ESN-175 (trade name, manufactured by Tohto Kasei Co., Ltd.) and others.

These biphenylene-based epoxy resin and naphthol-aralkyl-based epoxy resin may be used alone or in combination of both of them, but the total blending rate is preferably 20 mass % or more, more preferably 30 mass % or more, and still more preferably 50 mass % or more, with respect to the total amount of the epoxy resin, for making the resin show its favorable properties.

In particular among the epoxy resins above, a sulfur atom-containing epoxy resin having a structure represented by the General Formula (I) is most preferable from the viewpoints of reliability such as reflow resistance, moldability, and flame resistance.

The melt viscosity at 150° C. of the epoxy resin (A) according to the present invention is preferably 2 poises or less, more preferably 1 poise or less, and still more preferably 0.5 poise or less, from the viewpoint of flowability. The melt viscosity is a viscosity determined by using an ICI cone plate viscometer.

The hardening agent (B) for use in the present invention is not particularly limited, if it is commonly used in encapsulated epoxy-resin molding compounds, and examples thereof include novolak-based phenol resins prepared in condensation or cocondensation of a phenol such as phenol, cresol, resorcin, catechol, bisphenol A, bisphenol F, phenylphenol, or aminophenol, and/or a naphthol such as α-naphthol, β-naphthol, or dihydroxynaphthalene, with an aldehyde group-containing compound such as formaldehyde, benzaldehyde, or salicylic aldehyde in the presence of an acidic catalyst; aralkyl-based phenol resins prepared from a phenol and/or a naphthol and dimethoxy-p-xylene or bis(methoxymethyl)biphenyl, such as phenol-aralkyl resins, naphthol-aralkyl resin, and biphenyl-aralkyl resins; dicyclopentadiene-based phenol resins prepared in copolymerization of a phenol and/or a naphthol and dicyclopentadiene; terpene-modified phenol resins; triphenylmethane-based phenol resins; and the like, and these resins may be used alone or in combination of two or more.

Among them, biphenyl-based phenol resins are preferable from the viewpoints of flame resistance; aralkyl-based phenol resins are preferable from the viewpoints of reflow resistance and hardening efficiency; dicyclopentadiene-based phenol resins are preferable from the viewpoint of low hygroscopicity; triphenylmethane-based phenol resins are preferable from the viewpoints of heat resistance, low expansion coefficient and warping resistance; and novolak-based phenol resins are preferable from the viewpoint of hardening efficiency, and at least one of these phenol resins is preferably contained.

Examples of the biphenyl-based phenol resins include the phenol resins represented by the following General Formula (XIV) and the like.

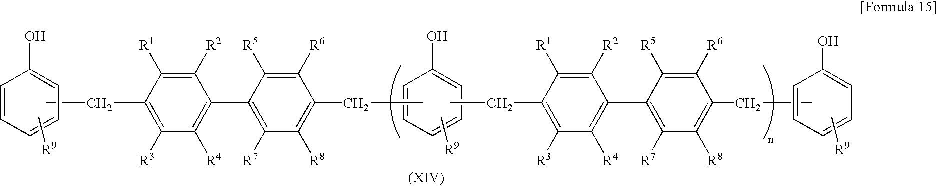

In Formula (XIV), R¹ to R⁹ may be the same as or different from each other, and are selected from a hydrogen atom, alkyl groups having 1 to 10 carbon atoms such as methyl, ethyl, propyl, butyl, isopropyl, and isobutyl, alkoxyl groups having 1 to 10 carbon atoms such as methoxy, ethoxy, propoxy, and butoxy, aryl group having 6 to 10 carbon atoms such as phenyl, tolyl, and xylyl, and aralkyl group having 6 to 10 carbon atoms such as benzyl and phenethyl; and in particular, a hydrogen atom and a methyl group are preferable. n is an integer of 0 to 10.

Examples of the biphenyl-based phenol resins represented by General Formula (XIV) include the compounds wherein all of R¹ to R⁹ are hydrogen atoms, and the like; and among them, a condensate mixture containing a condensate wherein n is 1 or more in an amount of 50 mass % or more is preferable, from the viewpoint of melt viscosity. Commercially available products of the compounds include MEH-7851 (trade name, manufactured by Meiwa Plastic Industries, Ltd.) and the like.

When a biphenyl-based phenol resin is used, the blending rate is preferably 30 mass % or more, more preferably 50 mass % or more, and still more preferably 60 mass % or more, with respect to the total amount of the hardening agents for making the resin show its favorable properties.

Examples of the aralkyl-based phenol resins include phenol-aralkyl resins, naphthol-aralkyl resins, and the like, and phenol-aralkyl resins represented by the following General Formula (XV) and the naphthol-aralkyl resin represented by the following General Formula (XVI) are preferable. Phenol-aralkyl resins represented by General Formula (XV) wherein R is a hydrogen atom and n is 0 to 8 on average are more preferable. Typical examples thereof include p-xylylene-based phenol-aralkyl resins, m-xylylene-based phenol-aralkyl resins, and the like. When the aralkyl-based phenol resin is used, the blending rate is preferably 30 mass % or more, more preferably 50 mass % or more, with respect to the total amount of the hardening agents for making the resin show its favorable properties.

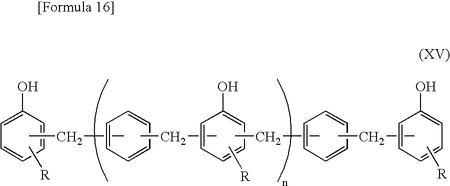

(in General Formula (XV), R is selected from a hydrogen atom and substituted or unsubstituted monovalent hydrocarbon groups having 1 to 10 carbon atoms; and n is an integer of 0 to 10).

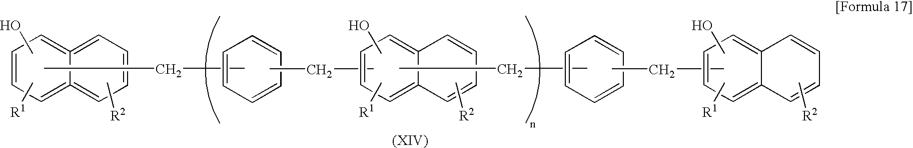

(in General Formula (XVI), R¹ to R² each are selected from a hydrogen atom and substituted or unsubstituted monovalent hydrocarbon groups having 1 to 10 carbon atoms and may be the same as or different from each other; and n is an integer of 0 to 10).

Examples of the dicyclopentadiene-based phenol resins include the phenol resins represented by the following General Formula (XVII) and the like.

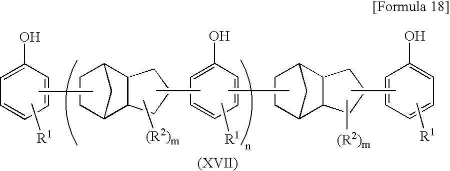

(in General Formula (XVII), each of R¹ and R² is selected independently from a hydrogen atom and substituted or unsubstituted monovalent hydrocarbon groups having 1 to 10 carbon atoms; n is an integer of 0 to 10; and m is an integer of 0 to 6).

When a dicyclopentadiene-based phenol resin is used, the blending rate is preferably 30 mass % or more, more preferably 50 mass % or more, with respect to the total amount of the hardening agents for making the resin show its favorable properties.

Examples of the triphenylmethane-based phenol resins include the phenol resins represented by the following General Formula (XVIII) and the like.

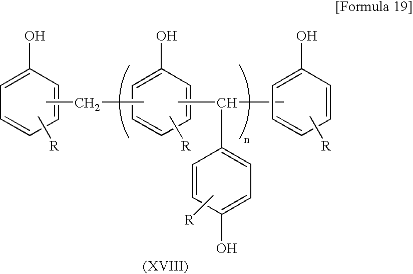

(in General Formula (XVIII), R is selected from a hydrogen atom and substituted or unsubstituted monovalent hydrocarbon groups having 1 to 10 carbon atoms; and n is an integer of 1 to 10). When a triphenylmethane-based phenol resin is used, the blending rate is preferably 30 mass % or more, more preferably 50 mass % or more, with respect to the total amount of the hardening agents for making the resin show its favorable properties.

Examples of the novolak-based phenol resins include phenolic novolak resins, cresol novolak resins, naphthol novolak resins, and the like; and among them, phenolic novolak resins are preferable. When a novolak-based phenol resin is used, the blending rate is 30 mass % or more, more preferably 50 mass % or more, with respect to the total amount of the hardening agents for making the resin show its favorable properties.

The biphenyl-based phenol resins, aralkyl-based phenol resins, dicyclopentadiene-based phenol resins, triphenylmethane-based phenol resins and novolak-based phenol resins may be used alone or in combination of two or more. The total blending rate is preferably 60 mass % or more, more preferably 80 mass % or more, with respect to the total amount of the hardening agents.

The melt viscosity at 150° C. of the hardening agent (B) for use in the present invention is preferably 2 poises or less, more preferably 1 poise or less, from the viewpoint of flowability. The melt viscosity is ICI viscosity.

The equivalence ratio of the epoxy resin (A) to the hardening agent (B), i.e., the ratio in number of the epoxy groups in epoxy resin to the hydroxyl groups in hardening agent (hydroxyl group number in hardening agent/epoxy group number in epoxy resin) is not particularly limited, but is preferably adjusted into the range of 0.5 to 2, more preferably 0.6 to 1.3, for reduction in the amount of the respective unreacted groups. It is more preferably adjusted into the range of 0.8 to 1.2, for obtaining an encapsulated epoxy-resin molding compound superior in moldability and reflow resistance.

Magnesium hydroxide (C) used in the present invention works as a flame retardant, and comprises magnesium hydroxide coated with silica. The method for coating magnesium hydroxide with silica is not specifically limited, but a preferable method is to add a water-soluble silicate salt to a slurry in which magnesium hydroxide is dispersed in water, and neutralize with acid to deposit silica on the surface of magnesium hydroxide. The temperature of the aqueous solution is preferably 5 to 100° C., and more preferably 50 to 95° C. from the viewpoint of coatability. After the neutralization, the pH of the slurry is preferably 6 to 10, and more preferably 6 to 9.5 from the viewpoint of coatability. The amount of silica used for coating is preferably 0.1 to 20% by mass, and more preferably 3 to 20% by mass relative to magnesium hydroxide in terms of SiO₂ conversion from the viewpoint of acid resistance, moldability such as flowability, and flame resistance. When the amount is less than 0.1% by mass, acid resistance tends to be poor, and when more than 20% by mass, flame resistance tends to be poor.

The magnesium hydroxide used in the coating is not particularly limited, but examples thereof include natural products produced by pulverizing natural ores, synthetic products prepared by alkali neutralization of an aqueous solution of magnesium salt, the derivatives of these magnesium hydroxide treated with a borate salt, phosphate salt, zinc salt, or the like. Also included are the composite metal hydroxides represented by the following Compositional Formula (XIX).

(Formula 20)
p(M¹ₐO_{b}).q(M²_{c}O_{d}).r(M³_{c}O_{d}).mH₂O (XIX)

(in Compositional Formula (XIX), M¹, M² and M³ are metal elements different from each other; M¹ is a magnesium atom; a, b, c, d, p, q and m are positive numbers; r is 0 or a positive number).

Among them, the compounds represented by Compositional Formula (XIX) wherein r is 0, i.e., the compounds represented by the following Compositional Formula (XIXa), are more preferable.

(Formula 21)
m(M¹ₐO_{b}).n(M²_{c}O_{d}).l(H₂O) (XIXa)

(in Compositional Formula (XIXa), M¹ and M² are metal elements different from each other; M¹ is a magnesium atom; and a, b, c, d, m, n and 1 are positive numbers).

M¹ and M² in Compositional Formulae (XIX) and (XIXa) are not particularly limited if M¹ is a magnesium atom and the other hand is an atom different from magnesium. From the viewpoint of flame-resistance, the atom other than magnesium is selected from metal elements in the third period, alkali-earth metal elements in group IIA, and metal elements in groups IVB, IIB, VIII, IB, IIIA and IVA, and M² is selected from transition metal elements in groups IIIB to IIB, to make M¹ and M² different from each other; and more preferably, M¹ is magnesium and M² is selected from calcium, aluminum, tin, titanium, iron, cobalt, nickel, copper and zinc. Preferably from the viewpoint of flowability, M¹ is magnesium and M² is zinc or nickel; and more preferably, M¹ is magnesium and M² is zinc. The molar ratio of p, q, and r in Compositional Formula (XIX) is not particularly limited, as far as the advantageous effects of the present invention is obtained; but preferably, r is 0, and the molar ratio of p and q, p/q, is 99/1 to 50/50. That is, the molar ratio of m and n, m/n, in Compositional Formula (XIXa) above is preferably 99/1 to 50/50.

Metal elements are determined, based on the long periodic table grouping typical elements in subgroup A and transition elements in subgroup B (“Dictionary of Chemistry 4”, reduce-size Ed., 30th, published by Kyoritsu Shuppan Co., Ltd., Feb. 15, 1987).

The above-mentioned magnesium hydroxide coated with silica is preferably overcoated with at least one selected from alumina, titania, and zirconia from the viewpoints of acid resistance and processability, particularly filterability at time of filtering the slurry.

The method for coating is not specifically limited. For example, alumina, titania, and zirconia can be deposited by adding sodium aluminate and acid for alumina, titanyl sulfate and alkali for titania, and zirconyl sulfate and alkali for zirconia, respectively, to a slurry of silica-coated magnesium hydroxide.

Furthermore, at least one selected from alumina, titania and zirconia may overcoat the silica coating layer by the above-mentioned method, or may be contained in the silica coating layer by coating magnesium hydroxide concurrently with silica. The method for the concurrent coating is, for example, to add a silicate salt and sodium aluminate to a slurry of magnesium hydroxide, and subsequently add acid to neutralize the silicate salt and sodium aluminate.

The proportion of the coating is, in any of the cases, preferably 0.03 to 10% by mass relative to magnesium hydroxide in terms of Al₂O₃, TiO₂, or ZrO₂ conversion. When the proportion is less than 0.03% by mass, acid resistance and filterability tend to be poor, and when more than 10% by mass, flame resistance tends to be poor.

The silica coating layer of the silica-coated magnesium hydroxide in the present invention is more preferably subjected to surface treatment with at least one surface treating agent selected from higher fatty acids, alkali metal salts of higher fatty acids, polyhydric alcohol higher fatty acid esters, anionic surfactants, phosphoric acid esters, silane coupling agents, aluminum coupling agents, titanate coupling agents, organosilanes, organosiloxanes, and organosilazanes from the viewpoint of improving acid resistance.

The above-mentioned higher fatty acids are preferably saturated or unsaturated fatty acids having 14 to 24 carbon atoms, and examples thereof include oleic acid and stearic acid. Preferable examples of alkali metal salts of higher fatty acids include sodium salts and potassium salts. Preferable examples of polyhydric alcohol higher fatty acid esters include glycerol monostearate, and glycerol monooleate. Examples of anionic surfactants include sulfuric acid ester salts of higher alcohols such as stearyl alcohol and oleyl alcohol, sulfuric acid ester salts of polyethylene glycol ether, amide bond-containing sulfuric acid ester salts, ester bond-containing sulfuric acid ester salts, ester bond-containing sulfonates, amide bond-containing sulfonates, ether bond-containing sulfonates, ether bond-containing alkyl allyl sulfonates, ester bond-containing alkylallyl sulfonates, and amide bond-containing alkylallyl sulfonates. As phosphoric acid ester, phosphotriesters, phosphodiesters, phosphomonoesters, or mixtures thereof are usable. Examples of phosphotriesters include trimethylphosphate, triethylphosphate, tripropylphosphate, tributyl phosphate, tripentylphosphate, trihexylphosphate, trioctylphosphate, triphenyl phosphate, tricresyl phosphate, trixylenyl phosphate, hydroxylphenyldiphenyl phosphate, cresyldiphenyl phosphate, xylenyldiphenyl phosphate, oleyl phosphate, and stearyl phosphate. Examples of phosphodiesters and phosphomonoesters include methyl acid phosphate, ethyl acid phosphate, isopropyl acid phosphate, butyl acid phosphate, 2-ethylhexyl acid phosphate, isodecyl acid phosphate, dilauryl acid phosphate, lauryl acid phosphate, tridecyl acid phosphate, monostearyl acid phosphate, distearyl acid phosphate, stearyl acid phosphate, isostearyl acid phosphate, oleyl acid phosphate, and behenyl acid phosphate.

The above-mentioned acidic phosphoric acid esters may be metal salts, specifically at least one metal salt selected from groups IA, IIA, IIB, and IIIA of the periodic table. Accordingly, preferable examples thereof include lithium salts, magnesium salts, calcium salts, strontium salts, barium salts, zinc salts, and aluminum salts.

The term silane coupling agent refers to organosilanes having hydrolysable groups such as alkoxyl groups together with reactive functional groups selected from amino groups, epoxy groups, vinyl groups, acryloyl groups, methacryloyl groups, mercapto groups, chlorine atom, and the like. Silane coupling agents are not specifically limited, and examples thereof include vinylethoxysilane, vinyl tris(2-methoxyethoxy)silane, γ-methacryloxypropyltrimethoxysilane, γ-aminopropyltrimethoxysilane, β-(3,4-epoxycyclohexyl)ethyltrimethoxysilane, γ-glycidoxypropyltrimethoxysilane, γ-mercaptopropyltrimethoxysilane, and 3-chloropropyltrimethoxysilane. Examples of aluminum coupling agents include acetylalkoxy aluminum diisopropylate, and examples of titanate coupling agents include isopropyltriisostearoyl titanate, isopropyltris(dioctylpyrophosphate)titanate, isopropyltri(N-aminoethylaminoethyl) titanate, and isopropyltridecylbenzenesulfonyl titanate.

As organosiloxane, organosiloxane oligomers including organodisiloxane and organopolysiloxanes are usable. Examples of organodisiloxanes include hexamethyldisiloxane, hexaethyldisiloxane, hexapropyldisiloxane, hexaphenyldisiloxane, and sodium methyl siliconate. Examples of organosiloxane oligomers include methylphenylsiloxane oligomers and phenylsiloxane oligomers. As the organosiloxane usable in the present invention, organopolysiloxanes are more preferable, and particularly those referred to as silicone oil are preferably used. Examples of such organopolysiloxanes include straight silicone oils such as dimethylpolysiloxane, methylhydrogenpolysiloxane, methylphenyl polysiloxane, and methylpolycyclosiloxane. Modified silicone oils having various organic groups are also preferably used. Examples of such modified silicone oils include polyether-modified, epoxy-modified, amino-modified, carboxyl-modified, mercapto-modified, carbinol-modified, methacryl-modified, and long chain alkyl-modified silicone oils, but are not limited thereto.

The term organosilane refers to organic silicon compounds having hydrolysable groups such as alkoxyl groups together with alkyl groups and/or aryl groups, and examples thereof include phenyltrimethoxysilane, diphenyldimethoxysilane, dimethyldimethoxysilane, tetraethoxysilane, trimethylchlorosilane, hexyltriethoxysilane, and decyltrimethoxysilane.

Examples of organosilazanes include hexamethyldisilazane, hexaethyldisilazane, hexaphenyldisilazane, hexaethylcyclotrisilazane, methylpolysilazane, and phenylpolysilazane.

The above-mentioned surface treating agent is used in the range of 0.1 to 20% by mass, preferably 0.5 to 15% by mass, and most preferably 1 to 10% by mass relative to magnesium hydroxide.

The surface treatment of magnesium hydroxide particles using such surface treating agent can be conducted by any of dry and wet process.

The surface treatment of magnesium hydroxide particles by wet process can be achieved, for example, the surface of magnesium hydroxide particles is coated with silica in a slurry of magnesium hydroxide as aforementioned, and then a surface treating agent is added to the slurry of magnesium hydroxide in an appropriate form, such as an emulsion, an aqueous solution or a dispersion liquid, and stirred and mixed at a temperature of 20 to 95° C., preferably under heating in the range of pH 6 to 12. Subsequently, the magnesium hydroxide particles are collected by filtration, water washed, dried, and pulverized.

The surface treatment of magnesium hydroxide particles by dry process is achieved, for example, the surface of magnesium hydroxide particles is coated with silica in a slurry of magnesium hydroxide as aforementioned, and the magnesium hydroxide particles are collected by filtration, water washed, dried, and pulverized. The pulverized particles are stirred and mixed with a surface treating agent at a temperature of 5 to 300° C., preferably under heating. The flame retardant in the present invention comprises, as described above, magnesium hydroxide particles including those having a silica coating layer on the surface, wherein the coated magnesium hydroxide particles are preferably further surface-treated with the above-mentioned surface treating agent, and has high acid resistance. Specifically according to the present invention, a flame retardant with excellent acid resistance can be provided by using an organosiloxane, a silane coupling agent or an organosilane as a surface treating agent. Among them, most preferable surface treating agent is organopolysiloxane. Among organopolysiloxanes, methylhydrogenpolysiloxane is still preferable from the viewpoint of acid resistance.

Furthermore, magnesium hydroxide particles coated with a silica coating layer, which is overcoated with or contains at least one selected from the above-mentioned alumina, titania, and zirconia, may be further surface-treated with a surface treating agent in the same manner.

The blending rate of magnesium hydroxide (C) is preferably 5 to 300 mass parts with respect to 100 mass parts of the epoxy resin (A). It is more preferably 10 to 200 mass parts and still more preferably 20 to 100 mass parts. A blending rate of less than 5 mass parts leads to deterioration in flame resistance, while a blending rate of more than 300 mass parts to deterioration in moldability such as flowability and acid resistance.

A metal oxide (D) may be used in the encapsulated epoxy-resin molding compound according to the present invention, for improvement in flame resistance. The metal oxide (D) is preferably an oxide of a metal selected from metal elements among the metal elements belonging to groups IA, IIA, and IIIA to VIA, so-called typical metal elements, and transition metal elements belonging to groups IIIB to IIB, and is preferably at least one oxide of magnesium, copper, iron, molybdenum, tungsten, zirconium, manganese or calcium from the viewpoints of flame resistance.

Metal elements are determined, based on the long periodic table grouping typical elements in subgroup A and transition elements in subgroup B (“Dictionary of Chemistry 4”, reduce-size Ed., 30th, published by Kyoritsu Shuppan Co., Ltd., Feb. 15, 1987).

The blending rate of the metal oxide (D) is preferably 0.1 to 100 mass parts, more preferably 1 to 50 mass parts, and still more preferably 3 to 20 mass parts, with respect to 100 mass parts of the epoxy resin (A). A blending rate of less than 0.1 mass part leads to deterioration in flame-retardant effect, while a blending rate of more than 100 mass parts to deterioration in flowability and hardening efficiency.

A hardening accelerator (E) may be added to the encapsulated epoxy-resin molding compound according to the present invention as needed for acceleration of the reaction between the epoxy resin (A) and the hardening agent (B). The hardening accelerator (E) is not particularly limited if it is commonly used in encapsulated epoxy-resin molding compounds, and examples thereof include cycloamidine compounds such as 1,8-diaza-bicyclo(5,4,0)undecene-7, 1,5-diaza-bicyclo(4,3,0)nonene, and 5,6-dibutylamino-1,8-diaza-bicyclo(5,4,0)undecene-7, and the intramolecular polarized compounds prepared by adding, to the compound above, a π bond-containing compound such as maleic anhydride, a quinone compound such as 1,4-benzoquinone, 2,5-toluquinone, 1,4-naphthoquinone, 2,3-dimethylbenzoquinone, 2,6-dimethylbenzoquinone, 2,3-dimethoxy-5-methyl-1,4-benzoquinone, 2,3-dimethoxy-1,4-benzoquinone, or phenyl-1,4-benzoquinone, diazo phenylmethane, or phenol resin; tertiary amines and the derivatives thereof such as benzyldimethylamine, triethanolamine, dimethylaminoethanol, and tris(dimethylaminomethyl)phenol; imidazoles such as 2-methylimidazole, 2-phenylimidazole, 2-phenyl-4-methylimidazole and the derivatives thereof; phosphine compounds such as tributylphosphine, methyldiphenylphosphine, triphenylphosphine, tris(4-methylphenyl)phosphine, diphenylphosphine, and phenylphosphine and the intramolecular polarized phosphorus compounds prepared by adding, to the phosphine compound above, a π bond-containing compound such as maleic anhydride, the quinone compound above, diazo phenylmethane, or phenol resin; tetraphenylboron salts such as tetraphenylphosphonium tetraphenyl borate, triphenylphosphine tetraphenyl borate, 2-ethyl-4-methylimidazole tetraphenyl borate, and N-methylmorpholine tetraphenyl borate and the derivatives thereof; and the like, and these compounds may be use alone or in combination of two or more. In particular, hardening accelerator preferably contains adducts of a phosphine compound and a quinone compound.

Among them, triphenylphosphine is preferable from the viewpoints of flame resistance and hardening efficiency; and adducts of a tertiary phosphine compound and a quinone compound are preferable from the viewpoints of flame resistance, hardening efficiency, flowability and release efficiency. Favorable examples of the tertiary phosphine compounds include, but are not limited to, tertiary phosphine compounds having alkyl or aryl groups such as tricyclohexylphosphine, tributylphosphine, dibutylphenylphosphine, butyldiphenylphosphine, ethyldiphenylphosphine, triphenylphosphine, tris(4-methylphenyl)phosphine, tris(4-ethylphenyl)phosphine, tris(4-propylphenyl)phosphine, tris(4-butylphenyl)phosphine, tris(isopropylphenyl)phosphine, tris(tert-butylphenyl)phosphine, tris(2,4-dimethylphenyl)phosphine, tris(2,6-dimethylphenyl)phosphine, tris(2,4,6-trimethylphenyl)phosphine, tris(2,6-dimethyl-4-ethoxyphenyl)phosphine, tris(4-methoxyphenyl)phosphine, tris(4-ethoxyphenyl)phosphine, and the like. Examples of the quinone compounds include o-benzoquinone, p-benzoquinone, diphenoquinone, 1,4-naphthoquinone, anthraquinone, and the like; and among them, p-benzoquinone is preferable from the viewpoints of moisture resistance and storage stability. An adduct of tris(4-methylphenyl)phosphine and p-benzoquinone is more preferable from the viewpoint of release efficiency. Further, an adduct of a phosphine compound having at least one alkyl group bound to the phosphorus atom and a quinone compound is preferable, from the viewpoints of hardening efficiency, flowability and flame-retardant.

The blending rate of the hardening accelerator is not particularly limited, if it is sufficient for showing a hardening-acceleration effect, but is preferably 0.005 to 2 mass %, more preferably 0.01 to 0.5 mass %, with respect to the encapsulated epoxy-resin molding compound. A blending rate of less than 0.005 mass % may lead to deterioration in short-term hardening efficiency, while a blending rate of more than 2 mass % to an excessive high hardening velocity, making it difficult to obtain a favorable molded product.

In the present invention, an inorganic filler (J) may be blended as needed. Addition of an inorganic filler is effective in reducing hygroscopicity and linear expansion coefficient and in increasing heat conductivity and strength, and examples thereof include powders of fused silica, crystalline silica, alumina, zircon, calcium silicate, calcium carbonate, potassium titanate, silicon carbide, silicon nitride, aluminum nitride, boron nitride, beryllia, zirconia, zircon, forsterite, steatite, spinel, mullite, titania, and the like; the spherical beads thereof, glass fiber, and the like. Examples of the flame-retarding inorganic fillers include aluminum hydroxide, zinc borate, zinc molybdate and the like. Commercially available zinc borate products include FB-290 and FB-500 (manufactured by U.S. Borax), FRZ-500C (manufactured by Mizusawa Industrial Chemicals, Ltd.), and the like; and those of zinc molybdenate include KEMGARD 911B, 911C, and 1100 (manufactured by Sherwin-Williams) and the like.

These inorganic fillers may be used alone or in combination of two or more. Among them, fused silica is preferable from the viewpoint of performance of filling and low linear expansion coefficient; alumina is preferable from the viewpoint of high heat conductivity; and the inorganic filler is preferably spherical in shape from the points of performance of filling and abrasion to mold.

The blending rate of the inorganic filler, together with magnesium hydroxide (C), is preferably 50 mass % or more, more preferably 60 to 95 mass %, and still more preferably 70 to 90 mass %, with respect to the encapsulated epoxy-resin molding compound, from the viewpoints of flame resistance, moldability, hygroscopicity, low linear expansion coefficient, high strength and reflow resistance. A blending rate of less than 60 mass % may lead to deterioration in flame resistance and reflow resistance, while a blending rate of more than 95 mass % to insufficient flowability and also to deterioration in flame resistance.

When an inorganic filler (J) is used, a coupling agent (F) is preferably added to the encapsulated epoxy-resin molding compound according to the present invention, for improvement in adhesiveness between the resin components and the filler. The coupling agent (F) is not particularly limited if it is commonly used in encapsulated epoxy-resin molding compounds, and examples thereof include various silane compounds such as primary, secondary and/or tertiary amino group-containing silane compounds, epoxysilanes, mercaptosilanes, alkylsilanes, ureidosilanes, and vinylsilanes; titanium compounds, aluminum chelates, aluminum/zirconium compounds, and the like. Typical examples thereof include silane coupling agents such as vinyl trichlorosilane, vinyltriethoxysilane, vinyltris(β-methoxyethoxy) silane, γ-methacryloxypropyltrimethoxysilane, β-(3,4-epoxycyclohexyl)ethyltrimethoxysilane, γ-glycidoxypropyltrimethoxysilane, γ-glycidoxypropylmethyldimethoxysilane, vinyltriacetoxysilane, γ-mercaptopropyltrimethoxysilane, γ-aminopropyltrimethoxysilane, γ-aminopropylmethyldimethoxysilane, γ-aminopropyltriethoxysilane, γ-aminopropylmethyldiethoxysilane, γ-anilino propyltrimethoxysilane, γ-anilinopropyltriethoxysilane, γ-(N,N-dimethyl)aminopropyltrimethoxysilane, γ-(N,N-diethyl)aminopropyltrimethoxysilane, γ-(N,N-dibutyl)aminopropyltrimethoxysilane, γ-(N-methyl)anilinopropyltrimethoxysilane, γ-(N-ethyl)anilinopropyltrimethoxysilane, γ-(N,N-dimethyl)aminopropyltriethoxysilane, γ-(N,N-diethyl)aminopropyltriethoxysilane, γ-(N,N-dibutyl)aminopropyltriethoxysilane, γ-(N-methyl)anilinopropyltriethoxysilane, γ-(N-ethyl)anilinopropyltriethoxysilane, γ-(N,N-dimethyl)aminopropylmethyldimethoxysilane, γ-(N,N-diethyl)aminopropylmethyldimethoxysilane, γ-(N,N-dibutyl)aminopropylmethyldimethoxysilane, γ-(N-methyl)anilinopropylmethyldimethoxysilane, γ-(N-ethyl)anilinopropylmethyldimethoxysilane, N-(trimethoxysilylpropyl)ethylenediamine, N-(dimethoxymethylsilylisopropyl)ethylenediamine, methyltrimethoxysilane, dimethyldimethoxysilane, methyltriethoxysilane, γ-chloropropyltrimethoxysilane, hexamethyldisilane, vinyltrimethoxysilane, and γ-mercaptopropylmethyldimethoxysilane; titanate coupling agents such as isopropyl triisostearoyl titanate, isopropyl tris(dioctylpyrophosphate)titanate, isopropyl tri(N-aminoethyl-aminoethyl)titanate, tetraoctyl bis(ditridecylphosphite) titanate, tetra(2,2-diallyloxymethyl-1-butyl)bis(ditridecyl)phosphite titanate, bis(dioctylpyrophosphate) oxyacetate titanate, bis(dioctylpyrophosphato)ethylene titanate, isopropyl trioctanoyl titanate, isopropyl dimethacryloy isostearoyl titanate, isopropyl tridodecylbenzenesulfonyl titanate, isopropyl isostearoyl diacryl titanate, isopropyl tri(dioctylphosphate) titanate, isopropyl tricumylphenyl titanate, and tetraisopropyl bis(dioctylphosphite) titanate; and the like, and these compounds may be used alone or in combination of two or more.

Among them, silane-coupling agents, particularly secondary amino group-containing silane-coupling agents are preferable from the viewpoints of flowability and flame resistance. The secondary amino group-containing silane-coupling agent is not particularly limited if it is a silane compound having a secondary amino group in the molecule, and examples thereof include γ-anilinopropyltrimethoxysilane, γ-anilinopropyltriethoxysilane, γ-anilinopropylmethyldimethoxysilane, γ-anilinopropylmethyldiethoxysilane, γ-anilinopropylethyldiethoxysilane, γ-anilinopropylethyldimethoxysilane, γ-anilinomethyltrimethoxysilane, γ-anilinomethyltriethoxysilane, γ-anilinomethylmethyldimethoxysilane, γ-anilinomethylmethyldiethoxysilane, γ-anilinomethylethyldiethoxysilane, γ-anilinomethylethyldimethoxysilane, N-(p-methoxyphenyl)-γ-aminopropyltrimethoxysilane, N-(p-methoxyphenyl)-γ-aminopropyltriethoxysilane, N-(p-methoxyphenyl)-γ-aminopropylmethyldimethoxysilane, N-(p-methoxyphenyl)-γ-aminopropylmethyldiethoxysilane, N-(p-methoxyphenyl)-γ-aminopropylethyldiethoxysilane, N-(p-methoxyphenyl)-γ-aminopropylethyldimethoxysilane, γ-(N-methyl)aminopropyltrimethoxysilane, γ-(N-ethyl)aminopropyltrimethoxysilane, γ-(N-butyl)aminopropyltrimethoxysilane, γ-(N-benzyl)aminopropyltrimethoxysilane, γ-(N-methyl)aminopropyltriethoxysilane, γ-(N-ethyl)aminopropyltriethoxysilane, γ-(N-butyl)aminopropyltriethoxysilane, γ-(N-benzyl)aminopropyltriethoxysilane, γ-(N-methyl)aminopropylmethyldimethoxysilane, γ-(N-ethyl)aminopropylmethyldimethoxysilane, γ-(N-butyl)aminopropylmethyldimethoxysilane, γ-(N-benzyl)aminopropylmethyldimethoxysilane, N-β-(aminoethyl)-γ-aminopropyltrimethoxysilane, γ-(β-aminoethyl)aminopropyltrimethoxysilane, N-β-(N-vinylbenzylaminoethyl)-γ-aminopropyltrimethoxysilane and the like. Among them, the coupling agent contains preferably in particular the aminosilane-coupling agents represented by the following General Formula (II):

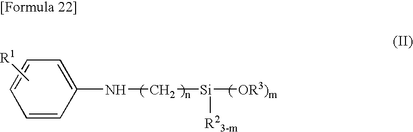

(in General Formula (II), R¹ represents a group selected from a hydrogen atom, alkyl groups having 1 to 6 carbon atoms, and alkoxyl group having 1 to 2 carbon atoms; R² represents a group selected from alkyl group having 1 to 6 carbon atoms and a phenyl group; R³ represents a methyl or ethyl group; n is an integer of 1 to 6; and m is an integer of 1 to 3).

The total blending rate of the coupling agents is preferably 0.037 to 5 mass %, more preferably 0.05 to 4.75 mass %, and still more preferably 0.1 to 2.5 mass %, with respect to the encapsulated epoxy-resin molding compound. A blending rate of less than 0.037 mass % may lead to deterioration in the adhesiveness to frame, while a blending rate of more than 5 mass % to deterioration in package moldability.

A phosphorus atom-containing compound (G) may be blended as needed in the encapsulated epoxy-resin molding compound according to the present invention for further improvement in flame resistance. The phosphorus atom-containing compound (G) is not particularly limited, as far as the advantageous effects of the present invention are obtained, and examples thereof include coated or uncoated red phosphorus; phosphorus and nitrogen-containing compounds such as cyclophosphazene; phosphonates such as nitrilotrismethylenephosphonic acid tricalcium salt and methane-1-hydroxy-1,1-diphosphonic acid dicalcium salt; phosphine and phosphine oxide compounds such as triphenylphosphine oxide, 2-(diphenylphosphinyl)hydroquinone, and 2,2-[(2-(diphenylphosphinyl)-1,4-phenylene)bis(oxymethylene)]bis-oxirane, and tri-n-octylphosphine oxide; phosphoric ester compounds; and the like, and these compounds may be used alone or in combination of two or more.

The red phosphorus is preferably a coated red phosphorus such as a red phosphorus coated with a thermosetting resin or coated with an inorganic compound and an organic compound.

Examples of the thermosetting resins used for the red phosphorus coated with a thermosetting resin include epoxy resins, phenol resins, melamine resins, urethane resins, cyanate resins, urea-formalin resins, aniline-formalin resins, furan resins, polyamide resins, polyamide-imide resins, polyimide resins, and the like, and these resins may be used alone or in combination of two or more. Red phosphorus may be coated with a thermosetting resin by coating and polymerizing the monomer or oligomer for the resin simultaneously thereon, or alternatively, the thermosetting resin may be hardened after coating. In particular, epoxy resins, phenol resins and melamine resins are preferable, from the viewpoint of the compatibility with the base resin blended in the encapsulated epoxy-resin molding compound.

Examples of the inorganic compounds used in the red phosphorus coated with an inorganic compound and an organic compound include aluminum hydroxide, magnesium hydroxide, calcium hydroxide, titanium hydroxide, zirconium hydroxide, hydrated zirconium oxide, bismuth hydroxide, barium carbonate, calcium carbonate, zinc oxide, titanium oxide, nickel oxide, iron oxide, and the like, and these compounds may be used alone or in combination of two or more. In particular, zirconium hydroxide, hydrated zirconium oxide, aluminum hydroxide and zinc oxide, which are superior in phosphate ion-trapping efficiency, are preferable.

Examples of the organic compounds used in the red phosphorus coated with an inorganic compound and an organic compound include low-molecular weight compounds such as those used in surface treatment as a coupling agent or a chelating agent, relatively high-molecular weight compounds such as thermoplastic resin and thermosetting resin, and the like; and these compounds may be used alone or in combination of two or more. In particular, thermosetting resins are preferable from the viewpoint of coating efficiency, and epoxy resins, phenol resins and melamine resins are more preferable from the viewpoint of the compatibility with the base resin blended in the encapsulated epoxy-resin molding compound.

When red phosphorus is coated with an inorganic compound and an organic compound, the order of coating is not limited, and the inorganic compound may be coated before the organic compound, the organic compound may be coated before the inorganic compound, or a mixture thereof may be coated simultaneously. The coating may be by physical adsorption, chemically binding, or others. The inorganic and organic compounds may be present separately, or part or all of them may present as bound to each other after coating.

As for the amounts of the inorganic and organic compounds, the mass ratio of the inorganic compound to the organic compound (inorganic compound/organic compound) is preferably 1/99 to 99/1, more preferably 10/90 to 95/5, and still more preferably 30/70 to 90/10, and the inorganic compound and the organic compounds or the raw monomer or oligomer thereof are preferably so adjusted that the ratio falls in the range above.

A coated red phosphorus such as the red phosphorus coated with a thermosetting resin or the red phosphorus coated with an inorganic compound and an organic compound can be prepared, for example, according to any one of known coating methods such as those described in JP-A No. 62-21704 and 52-131695, and others. The thickness of the coated film is not particularly limited, as far as the advantageous effects of the present invention are obtained, and coating may be performed uniformly or unevenly on the surface of red phosphorus.

The particle diameter of red phosphorus is preferably 1 to 100 μm, more preferably 5 to 50 μm, as average diameter (particle diameter at cumulative 50 mass % in particle size distribution). An average diameter of less than 1 μm leads to increase in the phosphate ion concentration in the molding product and deterioration in moisture resistance, while an average diameter of more than 100 μm to more frequent troubles such as deformation, short circuiting and disconnection of wire when the molding compound is used in a high-integration and high-density semiconductor device having a narrow pad pitch.

The phosphorus atom-containing compounds (G) contain preferably, phosphoric ester compounds and phosphine oxide, from the viewpoint of flowability among the compound above. The phosphoric ester compound is not particularly limited if it is an ester compound from a phosphoric acid and an alcohol or phenol compound, and examples thereof include trimethyl phosphate, triethyl phosphate, triphenyl phosphate, tricresyl phosphate, trixylenyl phosphate, cresyl diphenyl phosphate, xylenyl diphenyl phosphate, tris(2,6-dimethylphenyl)phosphate and aromatic condensed phosphoric esters, and the like. Among them, aromatic condensation phosphoric ester compounds represented by the following General Formula (III) are preferably contained, from the viewpoint of hydrolysis resistance.

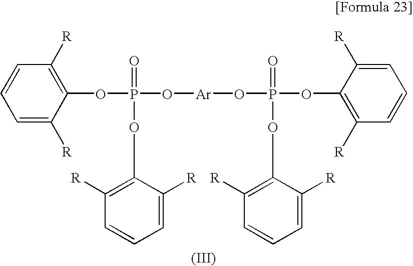

(in General Formula (III), eight groups R each represent an alkyl group having 1 to 4 carbon atoms and may be all the same or different from each other; and Ar represents an aromatic ring).

Examples of the phosphoric ester compounds represented by Formula (III) include the phosphoric esters represented by the following formulae (XX) to (XXIV) and the like.

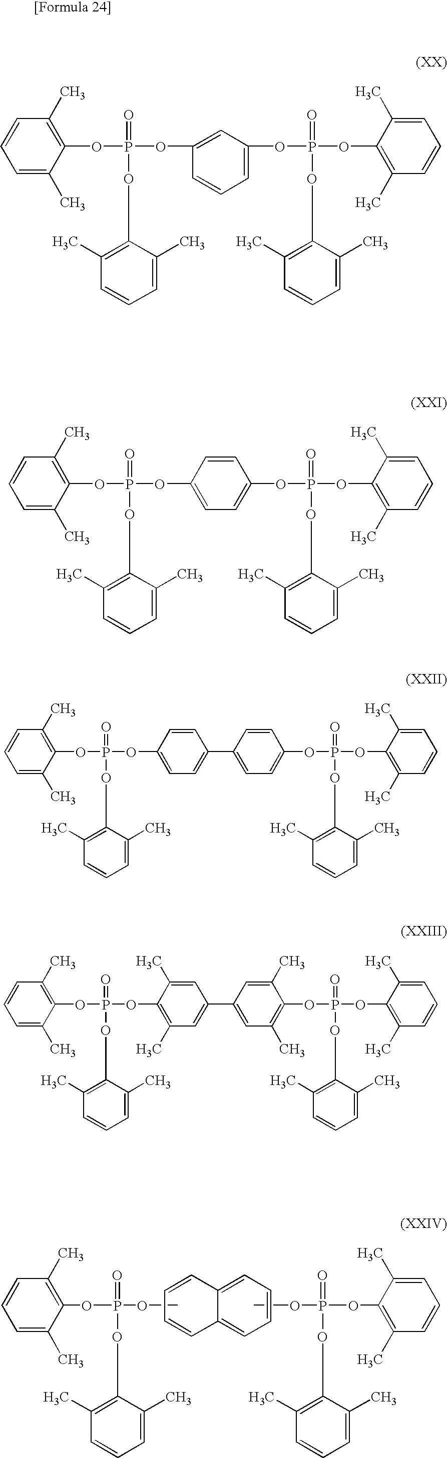

The blending rate of the phosphoric ester compound is preferably in the range of 0.2 to 3.0 mass % as phosphorus atom, with respect to all other components excluding the filler. A blending rate of less than 0.2 mass % leads to deterioration in flame-retarding efficiency, while a blending rate of more than 3.0 mass % to deterioration in moldability and moisture resistance and also in deterioration in appearance due to exudation of the phosphoric ester compound during molding.

For use as a flame retardant, the phosphine oxide is preferably a compound represented by the following General Formula (IV).

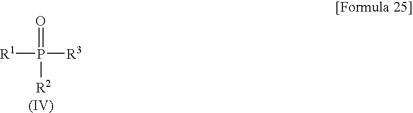

(in General Formula (IV), R¹, R² and R³ each represent a substituted or unsubstituted alkyl, aryl, or aralkyl group having 1 to 10 carbon atoms or a hydrogen atom and may be the same as or different from each other; however, all of the groups are not hydrogen atoms at the same time).

Among the phosphorus compounds represented by General Formula (IV), those having substituted or unsubstituted aryl groups as R¹ to R³ are preferable, and those having phenyl groups are particularly preferable, from the viewpoint of hydrolysis resistance.

The blending rate of the phosphine oxide is preferably 0.01 to 0.2 mass % as phosphorus atom, with respect to the encapsulated epoxy-resin molding compound. It is more preferably 0.02 to 0.1 mass % and still more preferably 0.03 to 0.08 mass %. A blending rate of less than 0.01 mass % may lead to deterioration in flame resistance, while a blending rate of more than 0.2 mass % to deterioration in moldability and moisture resistance.

Examples of the cyclophosphazenes include cyclic phosphazene compounds having the groups represented by the following Formula (XXV) and/or the following Formula (XXVI) as recurring units in the main chain skeleton, compounds having the groups represented by the following Formula (XXVII) and/or the following Formula (XXVIII) as recurring units different in the substitution site of the phosphorus atoms in the phosphazene ring, and the like.

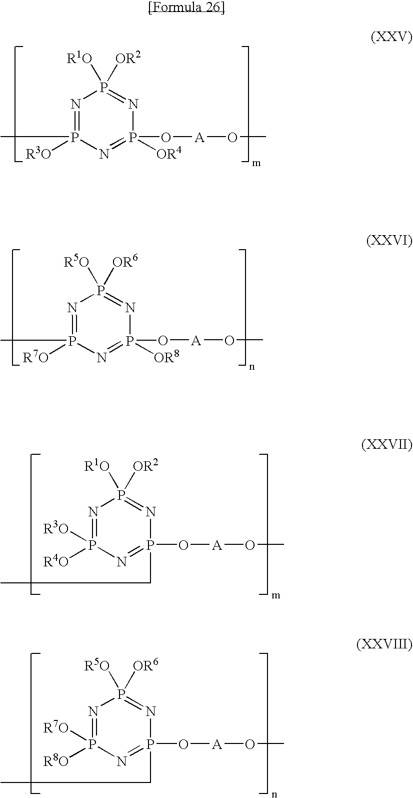

In Formulae (XXV) and (XXVII), m is an integer of 1 to 10; R¹ to R⁴ each represent a group selected from alkyl and aryl groups having 1 to 12 carbon atoms that may be substituted and a hydroxyl group, and may be the same as or different from each other. A is an alkylene or arylene group having 1 to 4 carbon atoms. In Formulae (XXVI) and (XXVIII), n is an integer of 1 to 10; R⁵ to R⁸ each represent a group selected from alkyl and aryl groups having 1 to 12 carbon atoms that may be substituted, and may be the same as or different from each other; and A represents an alkylene or arylene group having 1 to 4 carbon atoms. Also in the same Formulae, all m groups of R¹, R², R³, and R⁴ may be the same as or different from each other, and all n groups of R⁵, R⁶, R⁷, and R⁸ may be the same as or different from each other. In Formulae (XXV) to (XXVIII), the alkyl or aryl group having 1 to 12 carbon atoms that may be substituted represented by R¹ to R⁸ is not particularly limited, and examples thereof include alkyl groups such as methyl, ethyl, propyl, isopropyl, butyl, isobutyl, sec-butyl, and tert-butyl; aryl groups such as phenyl, 1-naphthyl, and 2-naphthyl; alkyl group-substituted aryl groups such as o-tolyl, m-tolyl, p-tolyl, 2,3-xylyl, 2,4-xylyl, o-cumenyl, m-cumenyl, p-cumenyl, and mesityl; aryl group-substituted alkyl groups such as benzyl and phenethyl; and the like, and examples of the substituent groups to the groups above include alkyl groups, alkoxyl groups, aryl groups, a hydroxyl group, an amino group, an epoxy group, a vinyl group, hydroxyalkyl groups, alkylamino groups and the like.

Among them, aryl groups are preferable, and a phenyl or hydroxyphenyl group is more preferable, from the viewpoints of the heat resistance and moisture resistance of the epoxy resin molding compound.

Also in Formulae (XXV) to (XXVIII), the alkylene or arylene group having 1 to 4 carbon atoms represented by A is not particularly limited, and example thereof include methylene, ethylene, propylene, isopropylene, butylene, isobutylene, phenylene, tolylene, xylylene, naphthylene and biphenylene groups, and the like; arylene groups are preferable, and among them, a phenylene group is more preferable from the viewpoints of the heat resistance and moisture resistance of the epoxy resin molding compound.

The cyclic phosphazene compound may be a polymer of one of the units represented by Formulae (XXV) to (XXVIII), a copolymer of the units represented by Formulae (XXV) and (XXVI), or a copolymer of the units represented by Formulae (XXVII) and (XXVIII); and, if it is a copolymer, the copolymer may be a random, block or alternating copolymer. The copolymerization molar ratio m/n is not particularly limited, but preferably 1/0 to 1/4, more preferably 1/0 to 1/1.5, for improvement in the heat resistance and strength of the hardened epoxy-resin product. The polymerization degree m+n is 1 to 20, preferably 2 to 8, and more preferably 3 to 6.

Favorable examples of the cyclic phosphazene compounds include the polymers represented by the following Formula (XXIX), the copolymers represented by the following Formula (XXX), and the like.

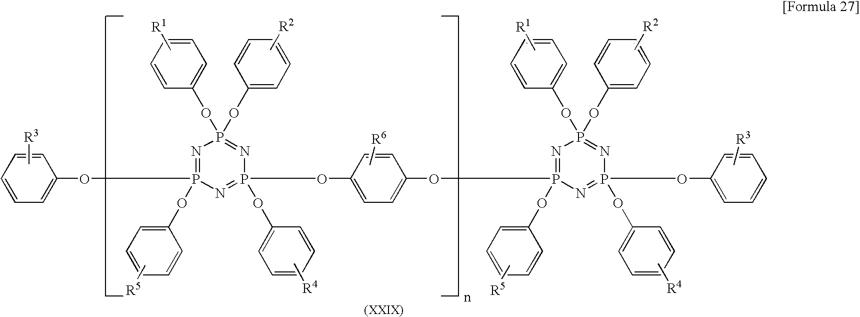

(in General Formula (XXIX), n is an integer of 0 to 9; and R¹ to R⁶ each independently represent a hydrogen atom or a hydroxyl group). [Formula 28]

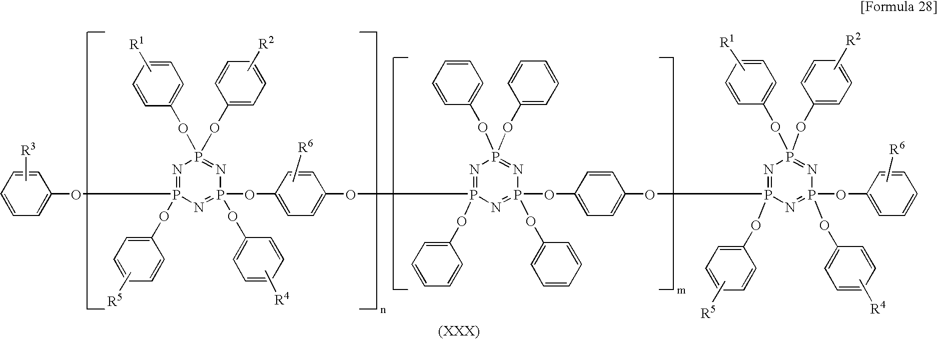

In General Formula (XXX), each of m and n is an integer of 0 to 9; R¹ to R⁶ each independently represent a hydrogen atom or a hydroxyl group. The cyclic phosphazene compound represented by Formula (XXX) above may be a copolymer containing n recurring units (a) and m recurring units (b) shown below alternately, blockwise, or random, but preferably a random copolymer.

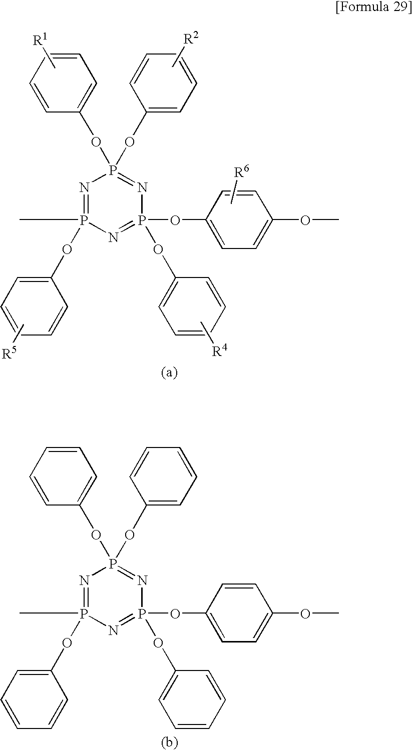

(in General Formula (a) above, R¹ to R⁶ each independently represent a hydrogen atom or a hydroxyl group).

Among them, the cyclic phosphazene compound is preferably a compound containing a polymer in which n in Formula (XXIX) is 3 to 6 as the principal component, or that containing a copolymer, in which all of R¹ to R⁸ in Formula (XXX) are hydrogen atoms or only one of them is a hydroxyl group, m/n is 1/2 to 1/3, and m+n is 3 to 6, as the principal component. Commercially available phosphazene compounds include SPE-100 (trade name, manufactured by Otsuka Chemical Co., Ltd.) and others.

The blending rate of the phosphorus atom-containing compound (G) is not particularly limited, and preferably 0.01 to 50 mass %, more preferably 0.1 to 10 mass %, and still more preferably 0.5 to 3 mass %, as phosphorus atom with respect to all other components excluding the inorganic filler (J). A blending rate of less than 0.01 mass % leads to insufficient flame resistance, while a blending rate of more than 50 mass % to deterioration in moldability and moisture resistance.

In the invention, a straight-chain oxidized polyethylene having a weight-average molecular weight of 4,000 or more (H) and an ester compound (I) of a copolymer of an α-olefin having 5 to 30 carbon atoms and maleic anhydride with a monovalent alcohol having 5 to 25 carbon atoms may also be contained, from the viewpoint of release efficiency in the invention. The straight-chain oxidized polyethylene having a weight-average molecular weight of 4,000 or more (H) functions as a releasing agent. The straight-chain polyethylene is a polyethylene having the number of carbons of the side alkyl chain approximately 10% or less of the number of carbons in the main alkyl chain, and generally separated as an polyethylene having a penetration of 2 or less.

The oxidized polyethylene is a polyethylene having a certain acid value. The weight-average molecular weight of the component (H) is preferably 4,000 or more from the viewpoint of release efficiency, and preferably 30,000 or less, more preferably 5,000 to 20,000, and still more preferably 7,000 to 15,000, from the viewpoints of adhesiveness and staining of mold and package. The weight-average molecular weight is a value determined by using a high-temperature GPC (gel-permeation chromatography). The method of determining the high temperature GPC in the present invention is as follows:

Analytical instrument: high temperature GPC manufactured by Waters

(solvent: dichlorobenzene

temperature: 140° C.,

standard substance: polystyrene)

Column: trade name: PLgel MIXED-B, manufactured by Polymer Laboratories

10 μm (7.5 mm×300 mm)×2 columns

Flow rate: 1.0 ml/minute (sample concentration: 0.3 wt/vol %)

(injection: 100 μl)

The acid value of the component (H) is not particularly limited, but preferably 2 to 50 mg/KOH, more preferably 10 to 35 mg/KOH, from the viewpoint of release efficiency.

The blending rate of the component (H) is not particularly limited, but preferably 0.5 to 10 mass %, more preferably 1 to 5 mass %, with respect to the epoxy resin (A). A blending rate of less than 0.5 mass % leads to deterioration in release efficiency, while a blending rate of more than 10 mass % to insufficient improvement in adhesiveness and resistance to staining of mold and package.

The ester compound (I) of a copolymer of an α-olefin having 5 to 30-carbon atoms and maleic anhydride with a monovalent alcohol having 5 to 25 carbon atoms (I) for use in the present invention also functions as a releasing agent, and is highly compatible both with the component (H) straight-chain oxidized polyethylene and the component (A) epoxy resin and effective in preventing deterioration in adhesiveness and mold/package staining.

The α-olefin having 5 to 30 carbon atoms used in the component (I) is not particularly limited, and examples thereof include straight-chain α-olefins such as 1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nonadecene, 1-eicosene, 1-dococene, 1-tricocene, 1-tetracocene, 1-pentacocene, 1-hexacocene, and 1-heptacocene; branched α-olefins such as 3-methyl-1-butene, 3,4-dimethyl-pentene, 3-methyl-1-nonene, 3,4-dimethyl-octene, 3-ethyl-1-dodecene, 4-methyl-5-ethyl-1-octadecene, and 3,4,5-triethyl-1-1-eicosene; and the like, and these olefins may be used alone or in combination of two or more. Among them, straight-chain α-olefin having 10 to 25 carbon atoms are preferable; and straight-chain α-olefins having 15 to 25 carbon atoms such as 1-eicosene, 1-dococene, and 1-tricocene are more preferable.

The monovalent alcohol having 5 to 25 carbon atoms for use in the component (I) is not particularly limited, and examples thereof include straight-chain or branched aliphatic saturated alcohols such as amyl alcohol, isoamyl alcohol, hexyl alcohol, heptyl alcohol, octyl alcohol, capryl alcohol, nonyl alcohol, decyl alcohol, undecyl alcohol, lauryl alcohol, tridecyl alcohol, myristyl alcohol, pentadecyl alcohol, cetyl alcohol, heptadecyl alcohol, stearyl alcohol, nonadecyl alcohol, and eicosyl alcohol; straight-chain or branched aliphatic unsaturated alcohols such as hexenol, 2-hexen-1-ol, 1-hexen-3-ol, pentenol, and 2-methyl-1-pentenol; alicyclic alcohols such as cyclopentanol and cyclohexanol; aromatic alcohols such as benzyl alcohol and cinnamyl alcohol; heterocyclic alcohols such as furfuryl alcohol; and the like, and these alcohols may be used alone or in combination of two or more. Among them, straight-chain alcohols having 10 to 20 carbon atoms are preferable, and straight-chain aliphatic saturated alcohols having 15 to 20 carbon atoms are more preferable.

The copolymer of an α-olefin having 5 to 30 carbon atoms and maleic anhydride in the component (I) according to the present invention is not particularly limited, and examples thereof include the compounds represented by the following General Formula (XXXI), the compounds represented by the following General Formula (XXXII), and the like; and commercial products thereof include Nissan Electol-WPB-1 prepared from 1-eicosene, 1-dococene and 1-tetracocene (trade name, manufactured by NOF Corporation Co., Ltd.) and others.

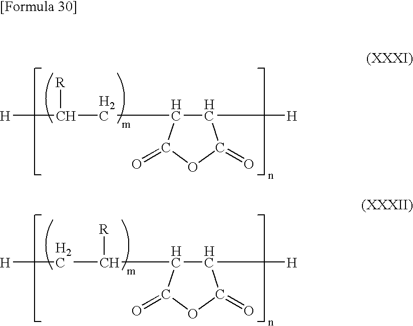

(in General Formulae (XXXI) and (XXXII), R is a group selected from monovalent aliphatic hydrocarbon groups having 3 to 28 carbon atoms; n is an integer of 1 or more; and m is a positive number). In General Formulae (XXXI) and (XXXII), m representing an amount (mole) of the α-olefin copolymerized with respect to 1 mole of maleic anhydride is not particularly limited, but preferably 0.5 to 10, more preferably 0.9 to 1.1.

The method of preparing the component (I) is not particularly limited, and any one of common copolymerization methods may be used. An organic solvent that dissolves the α-olefin and maleic anhydride may be used in the reaction. The organic solvent is not particularly limited; toluene is preferable; and an alcohol, ether, amine, or other solvent may also be used. The reaction temperature may vary according to the organic solvent used, but is preferably 50 to 200° C., more preferably 80 to 120° C., from the viewpoints of reactivity and productivity. The reaction period is not particularly limited if the copolymer can be prepared, but preferably 1 to 30 hours, more preferably 2 to 15 hours, and still more preferably 4 to 10 hours, from the viewpoint of productivity. After reaction, unreacted raw materials and solvent may be removed as needed, for example, by heating under reduced pressure. The temperature is preferably 100 to 220° C., more preferably 120 to 180° C.; the pressure is preferably 13.3×10³ Pa or less, more preferably 8×10³ Pa or less; and the period is preferably 0.5 to 10 hours. A reaction catalyst such as amine and acid may also be used as needed in the reaction. The pH of the reaction system is preferably, approximately 1 to 10.

The method of esterifying the copolymer in component (I) with a monovalent alcohol having 5 to 25 carbon atoms is not particularly limited, and any one of common methods, for example addition reaction of the monovalent alcohol and the copolymer, may be used. The reaction ratio of the copolymer to the monovalent alcohol in reaction is not particularly limited and arbitrary, but preferably adjusted properly according to the desirable encapsulated epoxy-resin molding compound, because the hydrophilicity thereof is controlled by the reaction molar ratio. An organic solvent that dissolves the copolymer may be used in the reaction. The organic solvent is not particularly limited; toluene is preferably; and an alcohol, ether, amine, or other solvent may be used. The reaction temperature may vary according to the kind of the organic solvent used, but is preferably 50 to 200° C., more preferably 80 to 120° C., from the viewpoints of reactivity and productivity. The reaction period is not particularly limited, but preferably 1 to 30 hours, more preferably 2 to 15 hours, and still more preferably 4 to 10 hours, from the viewpoint of productivity. After reaction, unreacted raw materials and solvent may be removed as needed, for example, by heating under reduced pressure. As for the condition, the temperature is preferably 100 to 220° C., more preferably 120 to 180° C.; the pressure is preferably 13.3×10³ Pa or less, more preferably 8×10³ Pa or less; and the period is preferably 0.5 to 10 hours. A reaction catalyst such as amine and acid may also be used as needed in the reaction. The pH of the reaction system is preferably, approximately 1 to 10.

Examples of the compounds (I) obtained by esterifying the copolymer of an α-olefin and maleic anhydride with a monovalent alcohol include the compounds having one or more unit selected from diesters represented by the following Formulae (a) and (b), and monoesters represented by Formulae (c) to (f) as the recurring units in the structure, and the like. A nonester represented by Formula (g) or (h), or a structure containing two —COOH groups due to ring opening of maleic anhydride may be also contained.

Examples of the compounds include:

(1) compounds with the main chain skeleton consisting of any one of the structures represented by Formulae (a) to (f);

(2) compounds with the main chain skeleton containing any two or more structures represented by Formulae (a) to (f) randomly, orderly, or blockwise; and

(3) compounds with the main chain skeleton containing any one or more structures represented by Formulae (a) to (f) and at least one of the structures represented by Formulae (g) and (h) randomly, orderly, or blockwise, and these compounds may be used alone or in combination of two or more. In addition, the compounds obtained by esterifying may contain one or both of (4) compounds with the main chain skeleton containing the structures represented by Formulae (g) and (h) randomly, orderly, or blockwise, and (5) compounds with the main chain skeleton consisting of the structure represented by Formula either (g) or (h).

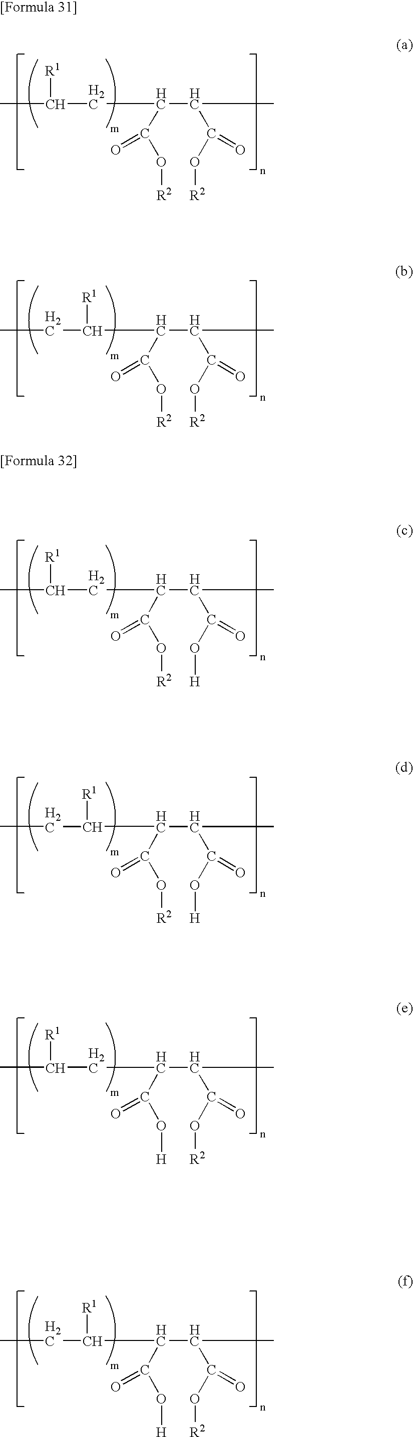

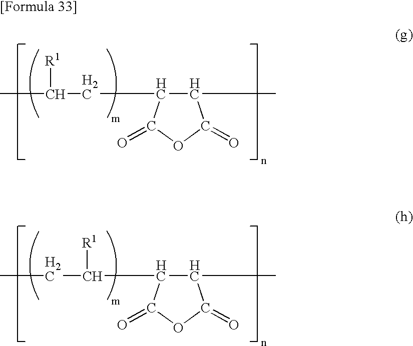

(in Formulae (a) to (h), R¹ is a group selected from monovalent aliphatic hydrocarbon groups having 3 to 28 carbon atoms; R² is a group selected from monovalent hydrocarbon groups having 5 to 25 carbon atoms; and m is a positive number).

In Formulae (a) to (h) above, m representing an amount (mole) of the α-olefin copolymerized with respect to 1 mole of maleic anhydride is not particularly limited, but preferably 0.5 to 10, more preferably 0.9 to 1.1.

The monoesterification rate of the component (I) is selected freely according to the combination with the component (H), but preferably 20% or more from the viewpoint of release efficiency, and the component (I) is preferably a compound containing one or more monomers represented by Formulae (c) to (f) in a total amount of preferably 20 mol % or more, more preferably 30 mol % or more.

The weight-average molecular weight of the component (I) is preferably 5,000 to 100,000, more preferably 10,000 to 70,000, and still more preferably 15,000 to 50,000, from the viewpoints of mold/package staining and moldability. A weight-average molecular weight of less than 5,000 leads to deterioration in the resistance to mold/package staining, while a molecular weight of more than 100,000 to increase in the softening point of the compound and deterioration in kneading efficiency and others. The weight-average molecular weight is a value obtained by using a normal-temperature GPC. The method of determining the weight-average molecular weight by normal-temperature GPC in the present invention is as follows:

Analytical instrument: LC-6C, manufactured by Shimadzu Corporation

Column: Shodex KF-802.5+KF-804+KF-806

Solvent: THF (tetrahydrofuran)

Temperature: room temperature (25° C.)

Standard substance: polystyrene

Flow rate: 1.0 ml/minute (sample concentration: approximately 0.2 wt/vol %)

Injection: 200 μl

The blending rate of the component (I) is not particularly limited, but preferably 0.5 to 10 mass %, more preferably 1 to 5 mass %, with respect to the epoxy resin (A). A blending rate of less than 0.5 mass % leads to deterioration in release efficiency, while a blending rate of more than 10 mass % to deterioration in reflow resistance.

At least one of the releasing agents according to the invention, i.e., component (H) and (I), is preferably mixed previously with part or all of the component (A) epoxy resin in preparation of the epoxy resin molding compound according to the present invention, from the viewpoints of reflow resistance and mold/package staining resistance. Preliminary mixing of at least one of the components (H) and (I) with the component (A) is effective in increasing dispersion of the releasing agent in the base resin and preventing deterioration in reflow resistance and mold/package staining.

The preliminary mixing method is not particularly limited, and may be any method, if at least one of the components (H) and (I) can be dispersed in the component (A) epoxy resin well, and, for example, the mixture of the components (H) and (I) and the component (A) are agitated at a temperature of room temperature to 220° C. for 0.5 to 20 hours. From the viewpoints of dispersibility and productivity, the temperature is preferably 100 to 200° C., more preferably 150 to 170° C., and the agitation period is preferably 1 to 10 hours, more preferably 3 to 6 hours.

At least one of the components (H) and (I) for preliminary mixing may be previously mixed with the total amount of the component (A); and preliminary mixing with part of the component (A) is also effective in giving a sufficient effect. In such a case, the amount of the component (A) used in preliminary mixing is preferably 10 to 50 mass % with respect to the total amount of the component (A).

Although preliminary mixing of component either (H) or (I) with component (A) is effective in improving dispersibility, preliminary mixing of both components (H) and (I) with component (A) is more effective and thus preferable. The order of adding the three components during preliminary mixing is not particularly limited, and all components may be added simultaneously or a component either (H) or (I) may be first added with component (A) and the other component added and mixed later.

A known non-halogen, non-antimony flame retardant may be blended as needed in the encapsulated epoxy-resin molding compound according to the present invention for further improvement in flame resistance. Examples thereof include nitrogen-containing compounds such as melamine, melamine derivatives, melamine-modified phenol resins, triazine ring-containing compounds, cyanuric acid derivatives, and isocyanuric acid derivatives; metal element-containing compounds such as aluminum hydroxide, zinc stannate, zinc borate, zinc molybdate, and dicyclopentadienyliron; and the like, and these compounds may be used alone or in combination of two or more.

An anion exchanger may also be added to the encapsulated epoxy-resin molding compound according to the present invention, for improvement in moisture resistance and high-temperature storage stability of semiconductor elements such as IC. The anion exchanger is not particularly limited, and any one of known exchangers may be used, and examples thereof include hydrotalcites, and water containing oxides of an element selected from magnesium, aluminum, titanium, zirconium, bismuth, and the like, and these compounds may be used alone or in combination of two or more. Among them, the hydrotalcites represented by the following Compositional Formula (XXXIII) are preferable.

(Formula 34)
Mg₁₋ₓAlₓ(OH)₂(CO₃)_{x/2}.mH₂O (XXXIII)

(in Formula (XXXIII), 0<x≦0.5, and m is a positive number)

In addition, other additives, including a releasing agent such as higher fatty acid, higher fatty acid metal salt, ester-based wax, polyolefin wax, polyethylene, or oxidized polyethylene; a colorant such as carbon black; and a stress-relaxing agent such as silicone oil or silicone rubber powder, may be added as needed to the encapsulated epoxy-resin molding compound according to the present invention.

The encapsulated epoxy-resin molding compound according to the present invention may be prepared by any method, if various raw materials are dispersed and mixed uniformly thereby, and, in a general method, raw materials in designated blending amounts are mixed sufficiently, for example in a mixer, mixed or melt-kneaded, for example in a mixing roll, extruder, mortar and pestle machine, or planetary mixer, cooled, and degasses and pulverized as needed. The raw materials may be tabletized into the size and mass suitable for the molding condition as needed.

A low-pressure transfer molding method is most commonly used as the method of producing electronic component devices such as semiconductor device by using the encapsulated epoxy-resin molding compound according to the present invention as a sealer, but other method such as injection molding or compression molding may be used instead. Yet another method such as discharging, molding, or printing may be used.

The electronic component devices according to the present invention having an element sealed with the encapsulated epoxy-resin molding compound according to the present invention include electronic component devices having an element, for example an active element such as semiconductor chip, transistor, diode, or thyristor or a passive element such as capacitor, resistor or coil, formed on a supporting material or mounting substrate such as lead frame, wired tape support, wiring board, glass, or silicon wafer, of which desirable regions are sealed with the encapsulated epoxy-resin molding compound according to the present invention, and the like.

The substrate for mounting is not particularly limited, and examples thereof include interposer substrates such as organic substrates, organic films, ceramic substrates and glass plate, glass plates for liquid crystal, MCM (Multi Chip Module) substrates, hybrid IC substrates, and the like.

Examples of the electronic component devices include semiconductor devices, and typical examples thereof include resin-sealed IC's prepared by mounting an element such as semiconductor chip on a lead frame (island, tab), connecting the terminal of the element such as bonding pad and lead areas by wire bonding or bumping, and then, sealing the element with the encapsulated-epoxy resin molding compound according to the present invention for example by transfer molding, such as DIP (Dual Inline Package), PLCC (Plastic Leaded Chip Carrier), QFP (Quad Flat Package), SOP (Small Outline Package), SOJ (Small Outline J-lead Package), TSOP (Thin Small Outline Package), and TQFP (Thin Quad Flat Package); TCP's (Tape Carrier Packages) prepared by sealing a semiconductor chip lead-bonded to a tape support with the encapsulated epoxy-resin molding compound according to the present invention; semiconductor devices mounted on bare chip, such as COB's (Chip On Board) and COG (Chip On Glass), prepared by sealing a semiconductor chip connected to a wiring formed on a wiring board or glass plate for example by wire bonding, flip-chip bonding, or soldering, with the encapsulated epoxy-resin molding compound according to the present invention; hybrid IC's prepared by sealing an active element such as semiconductor chip, transistor, diode, or thyristor and/or a passive element such as capacitor, resistor, or coil connected to a wiring formed on a wiring board or glass with the encapsulated epoxy-resin molding compound according to the present invention, for example by wire bonding, flip chip bonding, or solder; BGA's (Ball Grid Arrays), CSP's (Chip Size Packages), and MCP's (Multi Chip Packages) prepared by mounting a semiconductor chip on an interposer substrate having a terminal for connection to a MCM (Multi Chip Module) mother board, connecting the semiconductor chip to a wiring formed on the interposer substrate by bumping or wire bonding, and then, sealing the semiconductor chip-sided surface of the substrate with the encapsulated epoxy-resin molding compound according to the present invention; and the like. The semiconductor device may be a stacked package in which two or more elements are mounted as stacked (laminated) on a mounting substrate, or a simultaneously sealed package in which two or more elements are sealed simultaneously with an encapsulated epoxy-resin molding compound.

### EXAMPLES

Hereinafter, the present invention will be described with reference to Examples, but it should be understood that the scope of the present invention is not limited to these Examples.

(Preparation of Magnesium Hydroxide for Examples)

(1) Magnesium Hydroxide 1

20 liter of a slurry of magnesium hydroxide (concentration: 150 g/liter) was heated to 80° C., and 450 g as SiO₂ of sodium silicate was added. After that, sulfuric acid was added dropwise over a period of 1 hour until the slurry reached pH 9, and the slurry was heated at 80° C. for 1 hour. Surface-treated magnesium hydroxide was separated from the slurry by filtration, water washed, dried, and pulverized to obtain magnesium hydroxide 1.

(2) Magnesium Hydroxide 2

20 liter of a slurry of magnesium hydroxide (concentration: 150 g/liter) was heated to 80° C., and 300 g as SiO₂ of sodium silicate was added. After that, sulfuric acid was added dropwise over a period of 1 hour until the slurry reached pH 9, and the slurry was heated at 80° C. for 1 hour. Subsequently, an emulsion containing 90 g of methylhydrogenpolysiloxane to the slurry, and stirred at 80° C. for 1 hour. After that, surface-treated magnesium hydroxide was separated from the slurry by filtration, water washed, dried, and pulverized to obtain magnesium hydroxide 2.

(3) Magnesium Hydroxide 3

20 liter of a slurry of magnesium hydroxide (concentration: 150 g/liter) was heated to 80° C., and 90 g as SiO₂ Of sodium silicate was added. After that, sulfuric acid was added dropwise over a period of 1 hour until the slurry reached pH 9, and the slurry was heated at 80° C. for 1 hour. Then, with keeping the pH at 9, sodium aluminate in an amount of 30 g in terms of Al₂O₃ conversion and sulfuric acid were added, and heated for 1 hour. Subsequently, an emulsion containing 90 g of methylhydrogenpolysiloxane to the slurry, and stirred at 80° C. for 1 hour. After that, surface-treated magnesium hydroxide was separated from the slurry by filtration, water washed, dried, and pulverized to obtain magnesium hydroxide 3.

(4) Magnesium Hydroxide 4

20 liter of a slurry of magnesium hydroxide (concentration: 150 g/liter) was heated to 80° C., and 90 g as SiO₂ Of sodium silicate was added. After that, sulfuric acid was added dropwise over a period of 1 hour until the slurry reached pH 9, and the slurry was heated at 80° C. for 1 hour. Subsequently, an emulsion containing 90 g of decyltrimethoxysilane to the slurry, and stirred at 80° C. for 1 hour. After that, surface-treated magnesium hydroxide was separated from the slurry by filtration, water washed, dried, and pulverized to obtain magnesium hydroxide 4.

(5) Magnesium Hydroxide 5

20 liter of a slurry of magnesium hydroxide (concentration: 150 g/liter) was heated to 80° C., and 90 g as SiO₂ Of sodium silicate was added. After that, sulfuric acid was added dropwise over a period of 1 hour until the slurry reached pH 9, and the slurry was heated at 80° C. for 1 hour. Subsequently, 0.9 liter of a 10 wt % aqueous solution of sodium stearate to the slurry, and stirred at 80° C. for 1 hour. After that, surface-treated magnesium hydroxide was separated from the slurry by filtration, water washed, dried, and pulverized to obtain magnesium hydroxide 5.

(6) Magnesium Hydroxide 6

20 liter of a slurry of magnesium hydroxide (concentration: 150 g/liter) was heated to 80° C., and 1.5 g as SiO₂ of sodium silicate was added. After that, sulfuric acid was added dropwise over a period of 1 hour until the slurry reached pH 9, and the slurry was heated at 80° C. for 1 hour. Subsequently, surface-treated magnesium hydroxide was separated from the slurry by filtration, water washed, dried, and pulverized to obtain magnesium hydroxide 6.

(7) Magnesium Hydroxide 7

20 liter of a slurry of magnesium hydroxide (concentration: 150 g/liter) was heated to 80° C., and 900 g as SiO₂ of sodium silicate was added. After that, sulfuric acid was added dropwise over a period of 1 hour until the slurry reached pH 9, and the slurry was heated at 80° C. for 1 hour. Subsequently, surface-treated magnesium hydroxide was separated from the slurry by filtration, water washed, dried, and pulverized to obtain magnesium hydroxide 7.

(8) Magnesium Hydroxide 8

Magnesium hydroxide was separated from 20 liter of a slurry of magnesium hydroxide (concentration: 150 g/liter) by filtration, water washed, dried, and pulverized. With stirring the magnesium hydroxide by dry process, 90 g of methylhydrogenpolysiloxane was added, stirred for 10 minutes, and then heated at 150° C. for 1 hour to obtain magnesium hydroxide 8.

(9) Magnesium Hydroxide 9

Untreated magnesium hydroxide was used as magnesium hydroxide 9.

The compositions and properties of the each magnesium hydroxide prepared are summarized in Table 1.

TABLE 1
Table 1 Each magnesium hydroxides

| | Magnesium hydroxide for Examples | | | | | | | | |
|---|---|---|---|---|---|---|---|---|---|
| Item | 1 | 2 | 3 | 4 | 5 | 6 | 7 | 8 | 9 |
| Magnesium | 100 | 100 | 100 | 100 | 100 | 100 | 100 | 100 | 100 |
| hydroxide | | | | | | | | | |
| Silica | 15 | 10 | 3 | 3 | 3 | 0.05 | 30 | — | — |
| Alumina | — | — | 1 | — | — | — | — | — | — |
| Methylhydrogen- | — | 3 | 3 | — | — | — | — | 3 | — |
| polysiloxane | | | | | | | | | |
| Decyltrimethoxy- | — | — | — | 3 | — | — | — | — | — |
| silane | | | | | | | | | |
| Sodium stearate | — | — | — | — | 3 | — | — | — | — |

(Preparation of Releasing Agent)

A copolymer of a mixture of 1-eicosene, 1-dococene and 1-tetracocene with maleic anhydride (trade name Nissan Electol WPB-1, manufactured by NOF Corporation Co., Ltd.) was used as the copolymer of α-olefin and maleic anhydride, and stearyl alcohol as monovalent alcohol; these components were dissolved in toluene and allowed to react at 100° C. for 8 hours; the mixture was heated stepwise to 160° C. while toluene was removed, and allowed to react additionally under reduced pressure at 160° C. for 6 hours while the unreacted raw materials were removed, to give an esterified compound having a weight-average molecular weight 34,000 and a monoesterification rate of 70 mol % (component (I): releasing agent 3). The weight-average molecular weight is a value determined by GPC, by using THF (tetrahydrofuran) as the solvent.

### Examples 1 to 21 and Comparative Examples 1 to 7

Encapsulated epoxy-resin molding compounds of Examples 1 to 21 and Comparative Examples 1 to 7 were prepared, by mixing the components below respectively in the compositions in mass part shown in Tables 2 to 5, and roll-kneading the mixture under the condition of a kneading temperature 80° C. and a kneading period of 10 minute:

an epoxy resin: a biphenyl-based epoxy resin having an epoxy equivalence of 196 and a melting point of 106° C. (trade name: Epikote YX-4000H, manufactured by Japan Epoxy Resin Co., Ltd.: epoxy resin 1), a sulfur atom-containing epoxy resin having an epoxy equivalence of 245 and a melting point of 110° C. (trade name: YSLV-120TE, manufactured by Tohto Kasei Co., Ltd.: epoxy resin 2), a β-naphthol-aralkyl-based epoxy resin having an epoxy equivalence of 266 and a softening point of 67° C. (trade name: ESN-175, manufactured by Tohto Kasei Co., Ltd.: epoxy resin 3), or an o-cresol novolak-based epoxy resin having an epoxy equivalence of 195 and a softening point 65° C. (tradename: ESCN-190, manufactured by Sumitomo Chemical Co., Ltd.: epoxy resin 4);

a hardening agent: a phenol-aralkyl resin having a softening point of 70° C. and a hydroxyl equivalence of 175 (trade name: Milex XLC-3L, manufactured by Mitsui Chemicals, Inc.: hardening agent 1), a biphenyl-aralkyl resin having a softening point of 80° C. and a hydroxyl equivalence of 199 (trade name: MEH-7851, manufactured by Meiwa Plastic Industries, Ltd.: hardening agent 2), or a phenolic novolak resin having a softening point 80° C. and a hydroxyl equivalence of 106 (trade name: H-1, manufactured by Meiwa Plastic Industries, Ltd.: hardening agent 3);

a hardening accelerator: triphenylphosphine (hardening accelerator 1), triphenylphosphine 1,4-benzoquinone adduct (hardening accelerator 2), or tributylphosphine 1,4-benzoquinone adduct (hardening accelerator 3);

a coupling agent: γ-glycidoxypropyltrimethoxysilane (epoxysilane), or γ-anilino propyltrimethoxysilane (anilino silane) as a secondary amino group-containing silane-coupling agent;

a flame retardant: the coated magnesium hydroxide shown in Table 1 (magnesium hydroxide 1 to 9), zinc oxide, an aromatic condensed phosphoric ester (trade name: PX-200, manufactured by Daihachi Chemical Industry Co., Ltd.), triphenylphosphine oxide, antimony trioxide, or a brominated bisphenol-A epoxy resin having an epoxy equivalence of 397, a softening point of 69° C., and a bromine content of 49 mass % (trade name: YDB-400, manufactured by Tohto Kasei Co., Ltd.);

an inorganic filler: spherical fused silica having an average particle diameter of 14.5 μm and a specific surface area 2.8 m²/g; and

other additive: carnauba wax (releasing agent 1), a straight-chain oxidized polyethylene having a weight-average molecular weight of 8,800, a penetration of 1, and an acid value of 30 mg/KOH (component (H): releasing agent 2: trade name: PED153, manufactured by Clariant), the component (I) prepared above (releasing agent 3), and carbon black (trade name: MA-100, manufactured by Mitsubishi Chemical Corp.).

TABLE 2
Table 2 Blending composition 1

| | Example | | | | | | | |
|---|---|---|---|---|---|---|---|---|
| Component | 1 | 2 | 3 | 4 | 5 | 6 | 7 | 8 |
| Epoxy resin 1 | 100 | 100 | 100 | 100 | 100 | 100 | 100 | 100 |
| Epoxy resin 2 | | | | | | | | |
| Epoxy resin 3 | | | | | | | | |
| Epoxy resin 4 | | | | | | | | |
| Brominated epoxy resin | | | | | | | | |
| Hardening agent 1 | 89 | 89 | 89 | 89 | 89 | 89 | 89 | 89 |
| Hardening agent 2 | | | | | | | | |
| Hardening agent 3 | | | | | | | | |
| Hardening accelerator 1 | | | | | | | | |
| Hardening accelerator 2 | 2.0 | 2.0 | 2.0 | 2.0 | 2.0 | 2.0 | 2.0 | 2.0 |
| Hardening accelerator 3 | | | | | | | | |
| Magnesium hydroxide 1 | 100 | | | | | | | 100 |
| Magnesium hydroxide 2 | | 100 | | | | | | |
| Magnesium hydroxide 3 | | | 100 | | | | | |
| Magnesium hydroxide 4 | | | | 100 | | | | |
| Magnesium hydroxide 5 | | | | | 100 | | | |
| Magnesium hydroxide 6 | | | | | | 100 | | |
| Magnesium hydroxide 7 | | | | | | | 100 | |
| Magnesium hydroxide 8 | | | | | | | | |
| Magnesium hydroxide 9 | | | | | | | | |
| Zinc oxide | | | | | | | | |
| Phosphoric ester | | | | | | | | |
| Triphenylphosphine oxide | | | | | | | | |
| Antimony trioxide | | | | | | | | |
| Epoxysilane | 1.0 | 1.0 | 1.0 | 1.0 | 1.0 | 1.0 | 1.0 | |
| Anilinosilane | | | | | | | | 1.0 |
| Releasing agent 1 | 2.0 | 2.0 | 2.0 | 2.0 | 2.0 | 2.0 | 2.0 | 2.0 |
| Releasing agent 2 | | | | | | | | |
| Releasing agent 3 | | | | | | | | |
| Carbon black | 2.5 | 2.5 | 2.5 | 2.5 | 2.5 | 2.5 | 2.5 | 2.5 |
| Fused silica | 953 | 953 | 953 | 953 | 953 | 953 | 953 | 953 |
| Filler amount (mass %) | 84 | 84 | 84 | 84 | 84 | 84 | 84 | 84 |

TABLE 3
Table 3 Blending composition 2

| | Example | | | | | | | |
|---|---|---|---|---|---|---|---|---|
| Component | 9 | 10 | 11 | 12 | 13 | 14 | 15 | 16 |
| Epoxy resin 1 | 100 | 100 | 100 | 100 | 100 | | | |
| Epoxy resin 2 | | | | | | 100 | | |
| Epoxy resin 3 | | | | | | | 100 | |
| Epoxy resin 4 | | | | | | | | 100 |
| Brominated epoxy resin | | | | | | | | |
| Hardening agent 1 | 89 | 89 | 89 | 89 | 89 | 71 | 66 | 90 |
| Hardening agent 2 | | | | | | | | |
| Hardening agent 3 | | | | | | | | |
| Hardening accelerator 1 | | | | | 2.0 | | | |
| Hardening accelerator 2 | 2.0 | 2.0 | 2.0 | | | 2.0 | 2.0 | 2.0 |
| Hardening accelerator 3 | | | | 2.0 | | | | |
| Magnesium hydroxide 1 | 100 | 100 | 100 | 100 | 100 | 100 | 100 | 100 |
| Magnesium hydroxide 2 | | | | | | | | |
| Magnesium hydroxide 3 | | | | | | | | |
| Magnesium hydroxide 4 | | | | | | | | |
| Magnesium hydroxide 5 | | | | | | | | |
| Magnesium hydroxide 6 | | | | | | | | |
| Magnesium hydroxide 7 | | | | | | | | |
| Magnesium hydroxide 8 | | | | | | | | |
| Magnesium hydroxide 9 | | | | | | | | |
| Zinc oxide | 5.0 | | | | | | | |
| Phosphoric ester | | 10.0 | | | | | | |
| Triphenylphosphine oxide | | | 10.0 | | | | | |
| Antimony trioxide | | | | | | | | |
| Epoxysilane | 1.0 | 1.0 | 1.0 | 1.0 | 1.0 | 1.0 | 1.0 | 1.0 |
| Anilinosilane | | | | | | | | |
| Releasing agent 1 | 2.0 | 2.0 | 2.0 | 2.0 | 2.0 | 2.0 | 2.0 | 2.0 |
| Releasing agent 2 | | | | | | | | |
| Releasing agent 3 | | | | | | | | |
| Carbon black | 2.5 | 2.5 | 2.5 | 2.5 | 2.5 | 2.5 | 2.5 | 2.5 |
| Fused silica | 948 | 1007 | 1007 | 953 | 953 | 858 | 827 | 956 |
| Filler amount (mass %) | 84 | 84 | 84 | 84 | 84 | 84 | 84 | 84 |

TABLE 4
Table 4 Blending composition 3

| | Example | | | | |
|---|---|---|---|---|---|
| Component | 17 | 18 | 19 | 20 | 21 |
| Epoxy resin 1 | 100 | | 100 | 100 | 100 |
| Epoxy resin 2 | | | | | |
| Epoxy resin 3 | | | | | |
| Epoxy resin 4 | | 100 | | | |
| Brominated epoxy resin | | | | | |
| Hardening agent 1 | | | 89 | 89 | 89 |
| Hardening agent 2 | 102 | | | | |
| Hardening agent 3 | | 54 | | | |
| Hardening accelerator 1 | | | | | |
| Hardening accelerator 2 | 2.0 | 2.0 | 2.0 | 2.0 | 2.0 |
| Hardening accelerator 3 | | | | | |
| Magnesium hydroxide 1 | 100 | 150 | 10 | 200 | 100 |
| Magnesium hydroxide 2 | | | | | |
| Magnesium hydroxide 3 | | | | | |
| Magnesium hydroxide 4 | | | | | |
| Magnesium hydroxide 5 | | | | | |
| Magnesium hydroxide 6 | | | | | |
| Magnesium hydroxide 7 | | | | | |
| Magnesium hydroxide 8 | | | | | |
| Magnesium hydroxide 9 | | | | | |
| Zinc oxide | | | | | |
| Phosphoric ester | | | | | |
| Triphenylphosphine oxide | | | | | |
| Antimony trioxide | | | | | |
| Epoxysilane | 1.0 | 1.0 | 1.0 | 1.0 | 1.0 |
| Anilinosilane | | | | | |
| Releasing agent 1 | 2.0 | 2.0 | 2.0 | 2.0 | |
| Releasing agent 2 | | | | | 2.0 |
| Releasing agent 3 | | | | | 2.0 |
| Carbon black | 2.5 | 2.5 | 2.5 | 2.5 | 2.5 |
| Fused silica | 1019 | 716 | 1043 | 853 | 964 |
| Filler amount (mass %) | 84 | 84 | 84 | 84 | 84 |

TABLE 5
Table 5 Blending composition 4

| | Comparative Example | | | | | | |
|---|---|---|---|---|---|---|---|
| Component | 1 | 2 | 3 | 4 | 5 | 6 | 7 |
| Epoxy resin 1 | 100 | 100 | 100 | 100 | 100 | 100 | 85 |
| Epoxy resin 2 | | | | | | | |
| Epoxy resin 3 | | | | | | | |
| Epoxy resin 4 | | | | | | | |
| Brominated epoxy resin | | | | | | | 15 |
| Hardening agent 1 | 89 | 89 | 89 | 89 | 89 | 89 | 83 |
| Hardening agent 2 | | | | | | | |
| Hardening agent 3 | | | | | | | |
| Hardening accelerator 1 | | | | | | | |
| Hardening accelerator 2 | 2.0 | 2.0 | 2.0 | 2.0 | 2.0 | 2.0 | 2.0 |
| Hardening accelerator 3 | | | | | | | |
| Magnesium hydroxide 1 | | | | | | | |
| Magnesium hydroxide 2 | | | | | | | |
| Magnesium hydroxide 3 | | | | | | | |
| Magnesium hydroxide 4 | | | | | | | |
| Magnesium hydroxide 5 | | | | | | | |
| Magnesium hydroxide 6 | | | | | | | |
| Magnesium hydroxide 7 | | | | | | | |
| Magnesium hydroxide 8 | 100 | | | | | | |
| Magnesium hydroxide 9 | | 100 | | | | | |
| Zinc oxide | | | | 5.0 | | | |
| Phosphoric ester | | | | | 20.0 | | |
| Triphenylphosphine oxide | | | | | | 20.0 | |
| Antimony trioxide | | | | | | | 6.0 |
| Epoxysilane | 1.0 | 1.0 | 1.0 | 1.0 | 1.0 | 1.0 | 1.0 |
| Anilinosilane | | | | | | | |
| Releasing agent 1 | 2.0 | 2.0 | 2.0 | 2.0 | 2.0 | 2.0 | 2.0 |
| Releasing agent 2 | | | | | | | |
| Releasing agent 3 | | | | | | | |
| Carbon black | 2.5 | 2.5 | 2.5 | 2.5 | 2.5 | 2.5 | 2.5 |
| Fused silica | 953 | 953 | 1053 | 1048 | 1160 | 1160 | 1038 |
| Filler amount (mass %) | 84 | 84 | 84 | 84 | 84 | 84 | 84 |

The properties of the encapsulated epoxy-resin molding compounds prepared in Examples 1 to 21 and Comparative Examples 1 to 7 were determined in the following tests. Results are summarized in Tables 6 to 9.

(1) Spiral Flow

The flow distance (cm) of each encapsulated epoxy-resin molding compound was determined in a transfer-molding machine by molding it, by using a mold compatible with EMMI-1-66 for spiral flow measurement under the condition of a mold temperature of 180° C., a molding pressure of 6.9 MPa, and a hardening period of 90 seconds.

(2) Hardness when Hot

Each encapsulated epoxy-resin molding compound was molded into a circular disk having a diameter of 50 mm and a thickness of 3 mm under the molding condition of (1), and the hardness thereof was determined immediately by using a Shore D hardness meter.

(3) Flame-Resistant

Each encapsulated epoxy-resin molding compound was molded under the molding condition of (1) by using a mold for a sample having a thickness of 1/16 inch and after-baked at 180° C. additionally for 5 hours, and the flame resistance thereof is determined according to the test method of UL-94.

(4) Acid Resistance

A 80-pin flat package (QFP) having an external dimension of 20 mm×14 mm×2 mm carrying a silicon chip of 8 mm×10 mm×0.4 mm was molded and after-baked by using each of the encapsulated epoxy-resin molding compounds under the condition (3) above and additionally solder-plated, and the degree of surface corrosion was observed visually.

(5) Shear-Release Efficiency

Each of the encapsulated epoxy-resin molding compounds above was molded under the condition above in a mold for forming a circular disk having a diameter of 20 mm inserted a chrome-plated stainless steel plate of 50 mm in length×35 mm in width×0.4 mm in thickness therein, and the maximum pull-out force when the stainless steel plate was pulled out immediately after molding was determined. The same test was repeated continuously with the same stainless steel plate ten times, and the shear-release efficiency was evaluated by determining the average of the pull-out force in the second to tenth tests.

(6) Reflow Resistance

A 80-pin flat package (QFP) having an external dimension of 20 mm×14 mm×2 mm carrying a silicon chip of 8 mm×10 mm×0.4 mm was molded and after-baked by using each encapsulated epoxy-resin molding compound under the condition of (3), stored under the condition of 85° C. and 85% RH, and subjected to reflow treatment at 240° C. for 10 second at a particular time interval, and presence of cracks was observed. The reflow resistance was evaluated by the number of packages forming cracks among five test packages.

(7) Moisture Resistance

A 80-pin flat package (QFP) having an external dimension of 20 mm×14 mm×2.7 mm carrying a test silicon chip of 6 mm×6 mm×0.4 mm in size with aluminum wiring having a line width 10 μm and a thickness 1 μm on an oxide layer having thickness of 5 μm was molded and after-baked by using each encapsulated epoxy-resin molding compound under the condition of (3) and moistened after pretreatment; disconnection defects by aluminum wiring corrosion was analyzed at a particular time interval; and the moisture resistance thereof is evaluated, based on the number of defective packages among ten test packages.

In the pretreatment, the flat package was moistened under the condition of 85° C. and 85% RH for 72 hours and subjected to a vapor-phase reflow treatment at 215° C. for 90 seconds. Then, it is moistened under the condition of 0.2 MPa and 121° C.

(8) High-Temperature Storage Stability

A test silicon chip of 5 mm×9 mm×0.4 mm in size carrying aluminum wiring having a line width 10 μm and a thickness of 1 μm formed on the oxide layer having a thickness of 5 μm was mounted by using silver paste on a 42-alloy lead frame partially silver-plated; a 16-bottle DIP (Dual Inline Package), in which the bonding pad of the chip and the inner lead were connected to each other with Au wire at 200° C. with a thermosonic wire bonder, was prepared with each encapsulated epoxy-resin molding compound by molding and after-baking under the condition of (3), hardened, and stored in a tank at a high temperature of 200° C.; the DIP was withdrawn from the tank at a particular time interval and subjected to a continuity test; and the high-temperature storage stability was evaluated by the number of continuity defective packages among ten test packages.

TABLE 6
Table 6 Properties of sealants 1

| | | Example | | | | | | | |
|---|---|---|---|---|---|---|---|---|---|
| Property | | 1 | 2 | 3 | 4 | 5 | 6 | 7 | 8 |
| Flame resistance: | | | | | | | | | |
| Total time of | | 25 | 12 | 8 | 7 | 9 | 20 | 42 | 17 |
| flame remaining (s) | | | | | | | | | |
| Judgment | | V-0 | V-0 | V-0 | V-0 | V-0 | V-0 | V-0 | V-0 |
| Spiral flow (cm) | | 127 | 135 | 147 | 132 | 131 | 130 | 122 | 138 |
| Hardness when hot | | 74 | 78 | 80 | 77 | 77 | 76 | 75 | 77 |
| (Shore D) | | | | | | | | | |
| Acid resistance | | ◯ | ⊚ | ⊚ | ⊚ | ⊚ | Δ | ⊚ | ◯ |
| Release efficiency | | 6.5 | 5.8 | 5.2 | 6.2 | 6.2 | 6.1 | 6.1 | 5.7 |
| Reflow resistance | 48 h | 0/5 | 0/5 | 0/5 | 0/5 | 0/5 | 0/5 | 0/5 | 0/5 |
| | 72 h | 0/5 | 0/5 | 0/5 | 0/5 | 0/5 | 0/5 | 0/5 | 0/5 |
| | 96 h | 0/5 | 0/5 | 0/5 | 0/5 | 0/5 | 1/5 | 0/5 | 2/5 |
| | 168 h | 5/5 | 3/5 | 1/5 | 4/5 | 2/5 | 5/5 | 2/5 | 5/5 |
| Moisture resistance | 100 h | 0/10 | 0/10 | 0/10 | 0/10 | 0/10 | 0/10 | 0/10 | 0/10 |
| | 500 h | 0/10 | 0/10 | 0/10 | 0/10 | 0/10 | 0/10 | 0/10 | 0/10 |
| | 1000 h | 0/10 | 0/10 | 0/10 | 0/10 | 0/10 | 0/10 | 0/10 | 0/10 |
| | 1500 h | 0/10 | 0/10 | 0/10 | 0/10 | 0/10 | 0/10 | 0/10 | 0/10 |
| High-temperature | 500 h | 0/10 | 0/10 | 0/10 | 0/10 | 0/10 | 0/10 | 0/10 | 0/10 |
| storage stability | 1000 h | 0/10 | 0/10 | 0/10 | 0/10 | 0/10 | 0/10 | 0/10 | 0/10 |
| | 1500 h | 0/10 | 0/10 | 0/10 | 0/10 | 0/10 | 0/10 | 0/10 | 0/10 |
| | 2000 h | 0/10 | 0/10 | 0/10 | 0/10 | 0/10 | 0/10 | 0/10 | 0/10 |

TABLE 7
Properties of sealants 2

| | | Example | | | | | | | |
|---|---|---|---|---|---|---|---|---|---|
| Property | | 9 | 10 | 11 | 12 | 13 | 14 | 15 | 16 |
| Flame resistance: | | | | | | | | | |
| Total time of | | 8 | 5 | 6 | 14 | 37 | 33 | 18 | 43 |
| flame remaining (s) | | | | | | | | | |
| Judgment | | V-0 | V-0 | V-0 | V-0 | V-0 | V-0 | V-0 | V-0 |
| Spiral flow (cm) | | 120 | 138 | 132 | 129 | 111 | 130 | 110 | 102 |
| Hardness when hot | | 73 | 71 | 73 | 78 | 68 | 72 | 78 | 81 |
| (Shore D) | | | | | | | | | |
| Acid resistance | | ◯ | ◯ | ◯ | ◯ | ◯ | ◯ | ◯ | ◯ |
| Release efficiency | | 6.8 | 7.2 | 7.1 | 5.5 | 7.8 | 7.3 | 6.2 | 5.7 |
| Reflow resistance | 48 h | 0/5 | 0/5 | 0/5 | 0/5 | 0/5 | 0/5 | 0/5 | 0/5 |
| | 72 h | 0/5 | 0/5 | 0/5 | 0/5 | 0/5 | 0/5 | 0/5 | 0/5 |
| | 96 h | 0/5 | 0/5 | 0/5 | 3/5 | 1/5 | 0/5 | 1/5 | 5/5 |
| | 168 h | 5/5 | 0/5 | 2/5 | 5/5 | 5/5 | 3/5 | 5/5 | 5/5 |
| Moisture resistance | 100 h | 0/10 | 0/10 | 0/10 | 0/10 | 0/10 | 0/10 | 0/10 | 0/10 |
| | 500 h | 0/10 | 0/10 | 0/10 | 0/10 | 0/10 | 0/10 | 0/10 | 0/10 |
| | 1000 h | 0/10 | 0/10 | 0/10 | 0/10 | 0/10 | 0/10 | 0/10 | 0/10 |
| | 1500 h | 0/10 | 0/10 | 0/10 | 2/10 | 0/10 | 0/10 | 0/10 | 0/10 |
| High-temperature | 500 h | 0/10 | 0/10 | 0/10 | 0/10 | 0/10 | 0/10 | 0/10 | 0/10 |
| storage stability | 1000 h | 0/10 | 0/10 | 0/10 | 0/10 | 0/10 | 0/10 | 0/10 | 0/10 |
| | 1500 h | 0/10 | 0/10 | 0/10 | 0/10 | 0/10 | 0/10 | 0/10 | 0/10 |
| | 2000 h | 0/10 | 0/10 | 0/10 | 0/10 | 0/10 | 0/10 | 0/10 | 0/10 |

TABLE 8
Properties of sealants 3

| | | Example | | | | |
|---|---|---|---|---|---|---|
| Property | | 17 | 18 | 19 | 20 | 21 |
| Flame resistance: | | | | | | |
| Total time of | | 11 | 45 | 50 | 0 | 22 |
| flame remaining (s) | | | | | | |
| Judgment | | V-0 | V-0 | V-0 | V-0 | V-0 |
| Spiral flow (cm) | | 125 | 98 | 148 | 87 | 130 |
| Hardness when hot | | 72 | 82 | 75 | 70 | 75 |
| (Shore D) | | | | | | |
| Acid resistance | | ◯ | ◯ | ⊚ | Δ | ◯ |
| Release efficiency | | 7.3 | 8.2 | 4.3 | 9.8 | 3.6 |
| Reflow resistance | 48 h | 0/5 | 1/5 | 0/5 | 0/5 | 0/5 |
| | 72 h | 0/5 | 5/5 | 0/5 | 0/5 | 0/5 |
| | 96 h | 0/5 | 5/5 | 0/5 | 2/5 | 0/5 |
| | 168 h | 2/5 | 5/5 | 2/5 | 5/5 | 5/5 |
| Moisture resistance | 100 h | 0/10 | 0/10 | 0/10 | 0/10 | 0/10 |
| | 500 h | 0/10 | 0/10 | 0/10 | 0/10 | 0/10 |
| | 1000 h | 0/10 | 0/10 | 0/10 | 0/10 | 0/10 |
| | 1500 h | 0/10 | 0/10 | 0/10 | 0/10 | 0/10 |
| High-temperature | 500 h | 0/10 | 0/10 | 0/10 | 0/10 | 0/10 |
| storage stability | 1000 h | 0/10 | 0/10 | 0/10 | 0/10 | 0/10 |
| | 1500 h | 0/10 | 0/10 | 0/10 | 0/10 | 0/10 |
| | 2000 h | 0/10 | 0/10 | 0/10 | 0/10 | 0/10 |

TABLE 9
Properties of sealants 4

| | | Comparative Example | | | | | | |
|---|---|---|---|---|---|---|---|---|
| Property | | 1 | 2 | 3 | 4 | 5 | 6 | 7 |
| Flame resistance: | | | | | | | | |
| Total time of | | 10 | 36 | 125 | 83 | 18 | 22 | 4 |
| flame remaining (s) | | | | | | | | |
| Judgment | | V-0 | V-0 | NG | NG | V-0 | V-0 | V-0 |
| Spiral flow (cm) | | 115 | 95 | 146 | 133 | 155 | 149 | 143 |
| Hardness when hot | | 67 | 60 | 76 | 72 | 70 | 71 | 78 |
| (Shore D) | | | | | | | | |
| Acid resistance | | X | X | ⊚ | ⊚ | ⊚ | ⊚ | ⊚ |
| Release efficiency | | 10.8 | 15.3 | 3.2 | 4.5 | 8.8 | 7.6 | 3.3 |
| Reflow resistance | 48 h | 0/5 | 0/5 | 0/5 | 0/5 | 0/5 | 0/5 | 0/5 |
| | 72 h | 0/5 | 1/5 | 0/5 | 0/5 | 0/5 | 0/5 | 0/5 |
| | 96 h | 2/5 | 3/5 | 0/5 | 0/5 | 0/5 | 0/2 | 0/5 |
| | 168 h | 5/5 | 5/5 | 2/5 | 5/5 | 3/5 | 5/5 | 1/5 |
| Moisture resistance | 100 h | 0/10 | 0/10 | 0/10 | 0/10 | 0/10 | 0/10 | 0/10 |
| | 500 h | 0/10 | 0/10 | 0/10 | 0/10 | 0/10 | 0/10 | 0/10 |
| | 1000 h | 0/10 | 0/10 | 0/10 | 0/10 | 3/10 | 1/10 | 0/10 |
| | 1500 h | 0/10 | 0/10 | 2/10 | 0/10 | 7/10 | 3/10 | 2/10 |
| High-temperature | 500 h | 0/10 | 0/10 | 0/10 | 0/10 | 0/10 | 0/10 | 3/10 |
| storage stability | 1000 h | 0/10 | 0/10 | 0/10 | 0/10 | 0/10 | 0/10 | 10/10 |
| | 1500 h | 0/10 | 0/10 | 0/10 | 0/10 | 0/10 | 0/10 | 10/10 |
| | 2000 h | 0/10 | 0/10 | 0/10 | 0/10 | 0/10 | 0/10 | 10/10 |

Both of Comparative Examples 1 and 2 having magnesium hydroxide containing no silica-coated magnesium hydroxide in the present invention showed poor acid resistance, and Comparative Example 3 in which no flame retardant was added and Comparative Example 4 in which zinc oxide alone was used showed poor flame resistance and did not meet the UL-94 V-0 requirement. Furthermore, Comparative Examples 5 and 6 in which a phosphorus-based flame retardant was used alone showed poor moisture resistance. Comparative Example 7 in which a bromine-based flame retardant and an antimony-based flame retardant were used showed poor high-temperature exposure characteristics.

In contrast, all of the encapsulated epoxy-resin molding compounds obtained in Examples 1 to 21 containing all components according to the present invention satisfy the requirements of UL-94 V-0 and are superior in flame resistance and also in acid resistance and moldability. In addition, the encapsulated epoxy-resin molding compounds obtained in Examples 1 to 17 and 19 to 21 are superior in reflow resistance, and those in Examples 1 to 21 are also superior in reliability such as moisture resistance and high-temperature storage stability.

### INDUSTRIAL APPLICABILITY

The encapsulated epoxy-resin molding compound according to the present invention gives products such as electronic component devices superior in flame resistance and also in moldability and reliability such as reflow resistance, moisture resistance, High-temperature storage stability, and thus, is significantly valuable industrially.

1. An encapsulated epoxy-resin molding compound comprising an epoxy resin (A), a hardening agent (B), and magnesium hydroxide (C), wherein the magnesium hydroxide (C) contains magnesium hydroxide coated with silica.

2. The encapsulated epoxy-resin molding compound according to claim 1, wherein the magnesium hydroxide coated with silica has a coating layer consisting of silica in an amount of 0.1 to 20% by mass relative to magnesium hydroxide in terms of SiO₂ conversion.

3. The encapsulated epoxy-resin molding compound according to claim 1, wherein the magnesium hydroxide coated with silica contains magnesium hydroxide whose silica coating layer is overcoated with at least one selected from alumina, titania, and zirconia.

4. The encapsulated epoxy-resin molding compound according to claim 1, wherein the magnesium hydroxide coated with silica contains magnesium hydroxide whose silica coating layer contains at least one selected from alumina, titania, and zirconia.

5. The encapsulated epoxy-resin molding compound according to claim 3, wherein at least one selected from the group consisting of alumina, titania and zirconia overcoats the silica coating layer or is contained in the silica coating layer in an amount of 0.03 to 10% by mass relative to magnesium hydroxide in terms of Al₂O₃, TiO₂, and ZrO₂ conversion.

6. The encapsulated epoxy-resin molding compound according to claim 1, wherein the magnesium hydroxide coated with silica is surface-treated the silica coating layer with at least one surface treating agent selected from higher fatty acids, alkali metal salts of higher fatty acids, polyhydric alcohol higher fatty acid esters, anionic surfactants, phosphoric acid esters, silane coupling agents, aluminum coupling agents, titanate coupling agents, organosilanes, organosiloxanes, and organosilazanes.

7. The encapsulated epoxy-resin molding compound according to claim 3, wherein the magnesium hydroxide having the silica coating layer which is overcoated with or contains at least one selected from the group consisting of alumina, titania, and zirconia is further surface-treated with at least one surface treating agent selected from higher fatty acids, alkali metal salts of higher fatty acids, polyhydric alcohol higher fatty acid esters, anionic surfactants, phosphoric acid esters, silane coupling agents, aluminum coupling agents, titanate coupling agents, organosilanes, organosiloxanes, and organosilazanes.

8. The encapsulated epoxy-resin molding compound according to claim 1, wherein the magnesium hydroxide (C) is contained in an amount of 5 to 300 mass parts with respect to 100 mass parts of the epoxy resin (A).

9. The encapsulated epoxy-resin molding compound according to claim 1, further comprising a metal oxide (D).

10. The encapsulated epoxy-resin molding compound according to claim 9, wherein the metal oxide (D) is selected from the group consisting of oxides of typical metal elements and transition metal elements.

11. The encapsulated epoxy-resin molding compound according to claim 10, wherein the metal oxide (D) is at least one of the group consisting of the oxides of zinc, magnesium, copper, iron, molybdenum, tungsten, zirconium, manganese and calcium.

12. The encapsulated epoxy-resin molding compound according to claim 1, wherein the epoxy resin (A) contains at least one of the group consisting of a biphenyl-based epoxy resin, a bisphenol F-based epoxy resin, a stilbene-based epoxy resin, a sulfur atom-containing epoxy resin, a novolak-based epoxy resin, a dicyclopentadiene-based epoxy resin, a naphthalene-based epoxy resin, a triphenylmethane-based epoxy resin, a biphenylene-based epoxy resin and a naphthol-aralkyl-based phenol resin.

13. The encapsulated epoxy-resin molding compound according to claim 12, wherein the sulfur atom-containing epoxy resin is a compound represented by the following General Formula (I): 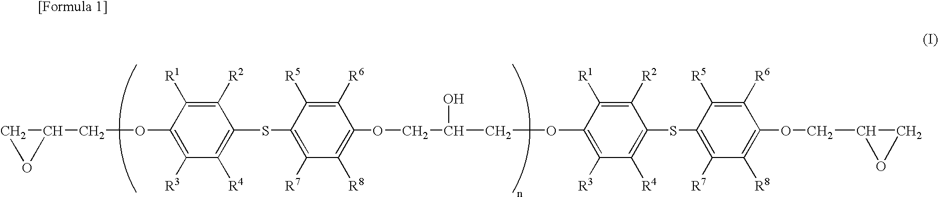
(in General Formula (I), R¹ to R⁸ are selected from a hydrogen atom and substituted or unsubstituted monovalent hydrocarbon groups having 1 to 10 carbon atoms and may be the same as or different from each other; and n is an integer of 0 to 3).

14. The encapsulated epoxy-resin molding compound according to claim 1, wherein the hardening agent (B) contains at least one of a biphenyl-based phenol resin, an aralkyl-based phenol resin, a dicyclopentadiene-based phenol resin, a triphenylmethane-based phenol resin and a novolak-based phenol resin.

15. The encapsulated epoxy-resin molding compound according to claim 1, further comprising a hardening accelerator (E).

16. The encapsulated epoxy-resin molding compound according to claim 15, wherein the hardening accelerator (E) contains an adduct of a phosphine compound with a quinone compound.

17. The encapsulated epoxy-resin molding compound according to claim 16, wherein the hardening accelerator (E) contains an adduct of a phosphine compound having at least one alkyl group bound to the phosphorus atom and a quinone compound.

18. The encapsulated epoxy-resin molding compound according to claim 1, further comprising a coupling agent (F).

19. The encapsulated epoxy-resin molding compound according to claim 18, wherein the coupling agent (F) contains a secondary amino group-containing silane-coupling agent.

20. The encapsulated epoxy-resin molding compound according to claim 19, wherein the secondary amino group-containing silane-coupling agent contains a compound represented by the following General Formula (II): 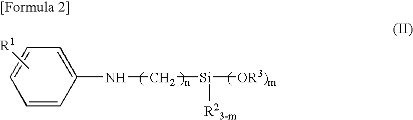
(in General Formula (II), R¹ is selected from a hydrogen atom, alkyl groups having 1 to 6 carbon atoms and alkoxyl groups having 1 to 2 carbon atoms; R² is selected from alkyl groups having 1 to 6 carbon atoms and a phenyl group; R³ represents a methyl or ethyl group; n is an integer of 1 to 6; and m is an integer of 1 to 3)

21. The encapsulated epoxy-resin molding compound according to claim 1, further comprising a phosphorus atom-containing compound (G).

22. The encapsulated epoxy-resin molding compound according to claim 21, wherein the phosphorus atom-containing compound (G) contains a phosphoric ester compound.

23. The encapsulated epoxy-resin molding compound according to claim 22, wherein the phosphoric ester compound contains a compound represented by the following General Formula (III): 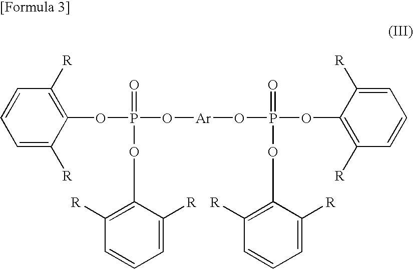
(in General Formula (III), eight groups R each represent an alkyl group having 1 to 4 carbon atoms and may be all the same or different from each other; and Ar represents an aromatic ring).

24. The encapsulated epoxy-resin molding compound according to claim 21, wherein the phosphorus atom-containing compound (G) contains a phosphine oxide, which in turn contains a phosphine compound represented by the following General Formula (IV): 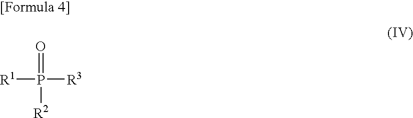
(in General Formula (IV), R¹, R² and R³ each represent a substituted or unsubstituted alkyl, aryl, or aralkyl group having 1 to 10 carbon atoms or a hydrogen atom and may be the same as or different from each other; however, all of the groups are not hydrogen atoms at the same time).

25. The encapsulated epoxy-resin molding compound according to claim 1, further comprising a straight-chain oxidized polyethylene having a weight-average molecular weight of 4,000 or more (H) and a compound (I) obtained by esterifying a copolymer of an α-olefin having 5 to 30 carbon atoms and maleic anhydride with a monovalent alcohol having 5 to 25 carbon atoms.

26. The encapsulated epoxy-resin molding compound according to claim 25, wherein at least one of the components (H) and (I) is mixed with part or all of the component (A) previously.

27. The encapsulated epoxy-resin molding compound according to claim 1, further comprising an inorganic filler (J).

28. The encapsulated epoxy-resin molding compound according to claim 27, wherein the total content of the magnesium hydroxide (C) and the inorganic filler (J) is 60 to 95 mass % with respect to the encapsulated epoxy-resin molding compound.

29. An electronic component device, comprising an element sealed with the encapsulated epoxy-resin molding compound according to claim 1.
